(19) United States
(12) Patent Application Publication
(10) Pub. No.: US 2017/0160884 A1
(43) Pub. Date: Jun. 8, 2017

(54) ELECTRONIC DEVICE AND METHOD FOR DISPLAYING A NOTIFICATION OBJECT

(71) Applicant: Samsung Electronics Co., Ltd., Gyeonggi-do (KR)

(72) Inventors: Ki Hyoung SON, Gyeonggi-do (KR); Young Mi KIM, Seoul (KR); Kyung Jun LEE, Gyeonggi-do (KR); Hyun Yeul LEE, Seoul (KR)

(73) Assignee: Samsung Electronics Co., Ltd.

(21) Appl. No.: 15/368,123

(22) Filed: Dec. 2, 2016

(30) Foreign Application Priority Data
Dec. 4, 2015 (KR) 10-2015-0172593

(51) Int. Cl. G06F 3/0482; G06F 3/0484; G06F 3/0488

(52) U.S. Cl. CPC G06F 3/0482; G06F 3/04886; G06F 3/04847

(57) ABSTRACT

A portable electronic device and method for displaying a notification object in the portable electronic device are provided. The portable electronic device includes a memory; a display; and a processor configured to receive a first user input for registering an object displayed on the display; register the object as a notification object in response to the first user input; and display the registered notification object in an indicator area of the display.

### PRIORITY

This application claims priority under 35 U.S.C. §119(a) to Korean Patent Application Serial No. 10-2015-0172593, which was filed in the Korean Intellectual Property Office on Dec. 4, 2015, the entire disclosure of which is incorporated herein by reference.

### BACKGROUND

1. Field of the Disclosure

The present disclosure relates generally to an electronic device and method for displaying a notification object in an indicator area of the electronic device.

2. Description of the Related Art

An electronic device may temporarily store an object that is selected from an application to copy or move the selected object. For example, the electronic device may provide a clipboard program that supports selecting, copying, cutting, and/or pasting a displayed object.

Further, the electronic device may provide a separate screen that displays the temporarily stored object, such that the user may identify the stored object. For example, the electronic device may display an execution screen of the clipboard program using a multi-window (or split windows), may display the stored object in a popup window, or may display the stored object in an object input panel (for example, a soft input panel (SIP)).

However, if a display is small and a multi-window is utilized, e.g., using a portable electronic device such as a smartphone, the stored object may be displayed in a relatively small area, which is difficult for a user to see. Even when a popup window or an object input panel is utilized, the popup window or the object input panel may hide an execution screen of the application program from which the object is selected, which is inconvenient to the user.

### SUMMARY

The present disclosure is made to address at least the above-mentioned problems and/or disadvantages and to provide at least the advantages described below.

An aspect of the present disclosure is to provide an electronic device and a method for displaying a stored object in an indicator area of the electronic device.

In accordance with an aspect of the present disclosure, a portable electronic device is provided, which includes a memory, a display, and a processor configured to receive a first user input for registering an object displayed on the display, register the object as a notification object in response to the first user input, and display the registered notification object in an indicator area of the display.

In accordance with another aspect of the present disclosure, a method of displaying a notification object in a portable electronic device is provided. The method includes receiving a first user input for registering an object displayed on a display of the portable electronic device, registering the object as a notification object in response to the first user input, and displaying the registered notification object in an indicator area of the display.

In accordance with another aspect of the present disclosure, a storage medium is provided, which stores a computer readable instruction, which when executed by a processor, instructs the processor to receive a first user input for registering an object displayed on a display, register the object as a notification object in response to the first user input, and display the registered notification object in an indicator area of the display.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates an electronic device according to an embodiment of the present disclosure;

FIG. 2 illustrates a processor according to an embodiment of the present disclosure;

FIG. 3 is a flowchart illustrating a method for displaying a notification object according to an embodiment of the present disclosure;

FIG. 4 is a flowchart illustrating a method for displaying a notification through a menu, according to an embodiment of the present disclosure;

FIG. 5 is a flowchart illustrating a method for displaying a notification through a soft input panel, according to an embodiment of the present disclosure;

FIG. 6 is a flowchart illustrating a method for displaying a notification object according to an embodiment of the present disclosure;

FIG. 7 is a flowchart illustrating a method for managing an object list according to an embodiment of the present disclosure;

FIG. 8 illustrates a screen displaying a notification object according to an embodiment of the present disclosure;

FIG. 9 illustrates screens for notification object management according to an embodiment of the present disclosure;

FIG. 10A illustrates an execution screen of a web search application for registering a notification object through a menu according to an embodiment of the present disclosure;

FIG. 10B illustrates a calculator application screen for registering a notification object through a menu according to an embodiment of the present disclosure;

FIG. 10C illustrates a message application screen for registering a notification object through a menu according to an embodiment of the present disclosure;

FIG. 11 illustrates a screen for registering a notification object through a soft input panel according to an embodiment of the present disclosure;

FIG. 12 illustrates screen for registering a notification object according to an embodiment of the present disclosure;

FIG. 13 illustrates screens for unregistering a notification object according to an embodiment of the present disclosure;

FIG. 14 illustrates screens for reregistering a notification object according to an embodiment of the present disclosure;

FIG. 15 illustrates screens for reregistering a notification object and for unregistering a notification object according to an embodiment of the present disclosure;

FIG. 16 illustrates screens for arranging an object list according to an embodiment of the present disclosure;

FIG. 17 illustrates screens for registering a notification of another object according to an embodiment of the present disclosure;

FIG. 18 illustrates screens for deleting a notification object according to an embodiment of the present disclosure;

FIG. 19 illustrates screens for deleting a plurality of notification objects according to an embodiment of the present disclosure;

FIG. 20 illustrates an electronic device in a network environment according to an embodiment of the present disclosure;

FIG. 21 illustrates an electronic device according to an embodiment of the present disclosure; and

FIG. 22 illustrates a program module according to an embodiment of the present disclosure.

### DETAILED DESCRIPTION

Hereinafter, various embodiments of the present disclosure are disclosed with reference to the accompanying drawings. However, the present disclosure is not intended to be limited by the various embodiments of the present disclosure to a specific embodiment and it is intended that the present disclosure covers all modifications, equivalents, and/or alternatives thereof, provided they come within the scope of the appended claims and their equivalents.

With respect to the descriptions of the accompanying drawings, like reference numerals refer to like elements.

The terms and words used in the following description and claims are not limited to the bibliographical meanings, but, are merely used to enable a clear and consistent understanding of the present disclosure. The terms used herein may have the same meanings that are generally understood by a person skilled in the art. In general, terms defined in a dictionary should be considered to have the same meanings as the contextual meanings in the related art, and unless clearly defined herein, should not be understood differently or as having excessively formal meanings. Even the terms defined in the present specification are not intended to be interpreted as excluding embodiments of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

Singular forms, such as “a,” “an,” and “the” include plural referents unless the context clearly dictates otherwise. Thus, for example, reference to “a component surface” includes reference to one or more of such surfaces.

The term “include,” “comprise,” “have”, “may include,” “may comprise” or “may have” used herein indicates disclosed functions, operations, or existence of elements, but does not exclude other functions, operations or elements.

For example, the expressions “A or B” and “at least one of A and/or B” may indicate (1) at least one A, (2) at least one B, or (3) both at least one A and at least one B.

The terms such as “1st,” “2nd,” “first,” “second,” etc., used herein may refer to modifying various different elements of various embodiments of the present disclosure, but are not intended to limit the elements. For example, “a first user device” and “a second user device” may indicate different user devices regardless of order or importance. Accordingly, a first component may be referred to as a second component and vice versa, without departing from the scope and spirit of the present disclosure.

In various embodiments of the present disclosure, when a component (for example, a first component) is referred to as being “operatively or communicatively coupled with/to” or “connected to” another component (for example, a second component), the first component may be directly connected to the second component or connected through another component (for example, a third component). However, when the first component is referred to as being “directly connected to” or “directly accessed by” the second component, no other component exists therebetween.

The expression “configured to” may be interchangeably used with “suitable for,” “having the capacity to,” “designed to,” “adapted to,” “made to,” or “capable of” according to context. Also, the term “configured to” may not necessarily indicate “specifically designed to” in terms of hardware. Instead, the expression “a device configured to” may indicate that the device and another device or part are “capable of.” For example, the expression “a processor configured to perform A, B, and C” may indicate a dedicated processor (e.g., an embedded processor) for performing a corresponding operation or a general purpose processor (e.g., a central processing unit (CPU) or application processor (AP)) for performing corresponding operations by executing at least one software program stored in a memory device.

Herein, an electronic device may include a smartphone, a tablet personal computer (PC), a mobile phone, a video telephone, an electronic book reader, a desktop PC, a laptop PC, a netbook computer, a workstation, a server, a personal digital assistant (PDA), a portable multimedia player (PMP), a Motion Picture Experts Group (MPEG-1 or MPEG-2) Audio Layer 3 (MP3) player, a mobile medical device, a camera, or a wearable device. The wearable device may include an accessory-type device (e.g., a watch, a ring, a bracelet, an anklet, a necklace, glasses, a contact lens, a head-mounted device (HMD)), a textile- or clothing-integrated-type device (e.g., an electronic apparel), a body-attached-type device (e.g., a skin pad or a tattoo), or a bio-implantable-type device (e.g., an implantable circuit).

An electronic device may also be a home appliance, such as a television (TV), a digital video/versatile disc (DVD) player, an audio, a refrigerator, an air conditioner, a cleaner, an oven, a microwave oven, a washing machine, an air cleaner, a set-top box, a home automation control panel, a security control panel, a television (TV) box (e.g., Samsung HomeSync™, Apple TV™, or Google TV™), a game console (e.g., Xbox™ or PlayStation™), an electronic dictionary, an electronic key, a camcorder, or an electronic picture frame

An electronic device may also include a medical device (e.g., a portable medical measurement device, such as a blood glucose measuring device, a heart rate measuring device, a blood pressure measuring device, a body temperature measuring device, etc., a magnetic resonance angiography (MRA) device, a magnetic resonance imaging (MRI) device, a computed tomography (CT) device, a scanner, an ultrasonic device, etc.), a navigation device, a global navigation satellite system (GNSS), an event data recorder (EDR), a flight data recorder (FDR), a vehicle infotainment device, an electronic device for a vessel (e.g., a navigation system, a gyrocompass, etc.), an avionics device, a security device, a head unit for a vehicle, an industrial or home robot, an automatic teller machine (ATM), a point of sales (POS) device, or an Internet of things (IoT) device (e.g., a light bulb, a sensor, an electric or gas meter, a sprinkler, a fire alarm, a thermostat, a streetlamp, a toaster, a piece of exercise equipment, a hot water tank, a heater, a boiler, etc.).

An electronic device may also include a part of furniture or a building/structure, an electronic board, an electronic signature receiving device, a projector, or a measuring instrument (e.g., a water meter, an electricity meter, a gas meter, a wave meter, etc.).

An electronic device may also be a flexible device.

An electronic device may also be a combination of any of the above-mentioned devices.

However, an electronic device is not limited to the above-mentioned devices, and may include, for example, new electronic devices with the development of new technology.

Herein, the term “user” may refer to a person who uses an electronic device or may refer to a device (e.g., an artificial intelligence electronic device) that uses an electronic device.

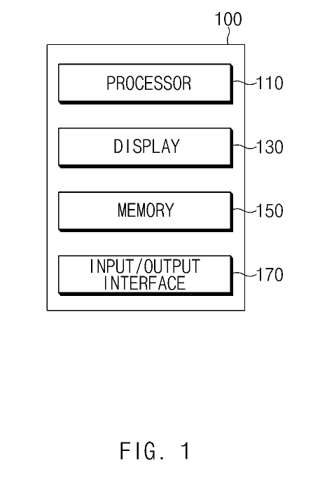

FIG. 1 illustrates an electronic device according to an embodiment of the present disclosure.

Referring to FIG. 1, the electronic device 100 supports selecting, copying, cutting, and/or pasting a displayed object (e.g., text). When a selected object is copied or cut, the electronic device 100 may store the object in a memory 150. The electronic device 100 may register the stored object as a notification object, and may display the notification object in an indicator area of a display 130.

The electronic device 100 includes a processor 110, a display 130, a memory 150, and an input/output interface 170. However, the configuration of the electronic device 100 is not limited thereto. For example, at least one of the above-mentioned elements may be omitted or at least one additional element may be further included.

The processor 110 may perform data processing or an operation related to communication and/or control of at least one of the other elements of the electronic device 100. The processor 110 may run an operating system (OS) or an application program to control a plurality of hardware or software elements connected to the processor 110, and may process various data and perform operations. The processor 110 may further include a graphic processing unit (GPU) and/or an image signal processor.

The processor 110 may allow the user to select an object from displayed objects through the input/output interface 170. The processor 110 may analyze a user input (e.g., a touch input or a gesture input) acquired through the input/output interface 170, and may determine whether the user input is a selection input for the displayed object. For example, if the user input (e.g., a long press input) is made on a specific point of the display 130 with a touch object (e.g., a finger or an electronic pen) for a specific time period, the processor 110 may determine that an object displayed at (or adjacent to) the specific point is selected.

If copying or cutting the selected object is performed (for example, by selecting a copy or cut function item from a menu related to the selected object), the processor 110 may store the copied or cut object in the memory 150.

Further, the processor 110 may display the copied or cut object in an area of the display 130. For example, the processor 110 may display the copied or cut in an area (e.g., an indicator area) in which the states of the functions supported by the electronic device 100 are displayed, such as an area in which a communication state, a battery state, and/or various configuration states of the electronic device 100 are displayed.

The indicator area may be an area in which it is determined whether an object is to be displayed, according to a security setting (or a user setting), and may be included in an uppermost level layer of the screen so that the object may be displayed even when the screen is switched as long as the display of the object does not violate the security setting (or the user setting). Accordingly, because the cut or copied object is displayed in the indicator area, the user may identify it as a notification object, even when the screen is switched.

The display 130 may present various content (e.g., text, an image, a video, an icon, a symbol, etc.). The display 130 may include a touch screen, and may receive a touch, gesture, proximity or hovering input from an electronic pen or a part of a body of the user.

The memory 150 may store instructions or data related to at least one of the other elements of the electronic device 100. The memory 150 may store software and/or a program. For example, the memory 150 may store an application program (e.g., a clip board program) that supports selecting, copying, cutting, and/or pasting the displayed object. Further, the memory 150 may store a module, a program, a routine, a set of instructions, or a process for performing functions related to displaying the notification object. In addition, the memory 150 may store at least one command and/or data for performing the functions supported by the electronic device 100, and the command or data may be loaded in the memory 150, by the processor 110, when the related functions are performed and may be executed based on a defined routine.

The input/output interface 170 may transfers an instruction or data input from a user or another external device to another element of the electronic device 100. Further, the input/output interface 170 may output instructions or data received from another elements of the electronic device 100 to the user or another external device. For example, the input/output interface 170 may include a touch panel, a (digital) pen sensor, a key, an ultrasonic input device, and/or an audio module.

If the user inputs a command for selecting, copying, cutting, or pasting the displayed object, the input/output interface 170 may deliver the corresponding input (and/or the event) to the processor 110. For example, the input/output interface 170 may deliver the user input (e.g., a touch input or a gesture input) for selecting, copying, cutting, or pasting the displayed object to the processor 110. Further, if a function related to a notification object is selected (for example, registration of a notification object, unregistration of a notification object, reregistration of a notification object, or deletion of a notification object), the input/output interface 170 may deliver the corresponding input (and/or the event) to the processor 110.

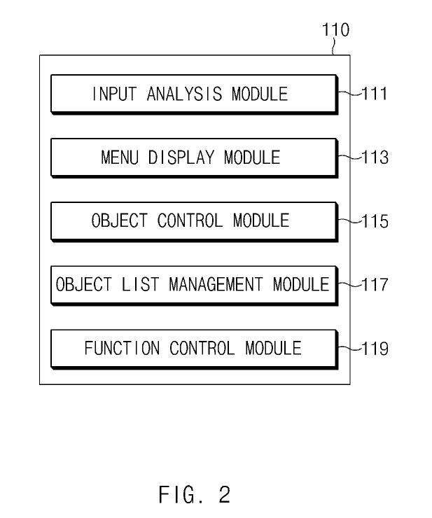

FIG. 2 illustrates a processor according to an embodiment of the present disclosure.

Referring to FIG. 2, the processor 110 includes an input analysis module 111, a menu display module 113, an object control module 115, an object list management module 117, and a function control module 119. The input analysis module 111 may analyze an input received from the input/output interface 170. The input analysis module 111 may analyze a type, a location (e.g., a coordinate on a screen), and/or a duration of an input.

The processor 110 may provide a user interface for selecting, copying, cutting, and/or pasting a displayed object, based on a result from the input analysis module 111. When the input is a trigger signal and is for starting selection of a displayed object (for example, a long press input is made on or around the displayed object), the processor 110 may output an image that indicates selection of the displayed object at (or adjacent to) the location at which the input is made. When the input is for selecting an item including an object (e.g., an image including text or a speech bubble), the processor 110 may output a menu related to the item through a menu display module 113.

If the user selects an object from among a plurality of displayed objects by using a display object that indicates selection of an object, the processor 110 may display a menu related to the selected object through the menu display module 113. For example, if the user drags a displayed object in a specific direction, the processor 110 may designate the dragged object as a selected object. In this case, the processor 110 may allow the user to intuitively identify the selected object by changing the way the selected object is displayed (e.g., using color inversion). Further, if the user drags the displayed object and then removes the touch object, e.g., the user's finger, from the screen, the processor 110 may output a menu related to the selected object at (or adjacent to) a location at which the touch object is removed from the screen.

The menu display module 113 may output a menu related to the selected object or a menu related to an item including the object. When the object is text, the menu display module 113 may output a menu including functions related to the text, such as selecting, copying, and/or cutting, or registering an item as a notification object. Further, the menu display module 113 may output a menu including functions related to an application (e.g., a message application) that uses the item (for example, a speech bubble), such as deleting an item, copying an object included in the item, or registering an alarm.

The object control module 115 may control storage, display, or deletion of the selected object or the object included in the item.

If an input for registering a selected object or an object included in the item is acquired (for example, if a notification registration function item included in the menu is selected), the selected object or the object included in the item may be registered as a notification object. For example, the object control module 115 may register the selected object or the object included in the item in an object list as being in a notification registered state (or a pinned state) through an object list management module 117. Unless the object stored in the memory 150 is deleted, the object list may include information for managing the notification objects.

The object control module 115 may store the notification object in the memory 150. Further, the object control module 115 may display the notification object in an area (for example, the indicator area) of the display 130. The object control module 115 may control the notification object not to overlap another display object (for example, a communication state image, a battery state image, or various configuration state images) output in the indicator area when the notification object is output. The object control module 115 may alternately display the notification object and another display object at specific time intervals. Further, the object control module 115 may display the notification object in the indicator area, except for where the other display object is displayed.

If an input for unregistering a notification object is received, the object control module 115 may designate the notification object as a notification enabled object, and then change the notification state of the corresponding object to a notification registration releasing state (or an unpinned state) or a notification registration enabled state (or a pinnable state) through the object list management module 117. In the notification registration enabled state, the object may not be notified to the user (e.g., the object isn't displayed on the display), but may be notified to the user (e.g., the object is displayed on the display) whenever the user select the object. Accordingly, the object may not be deleted from the memory 150 in the notification registration enabled state. Further, the object control module 115 may terminate output of the notification object.

The object control module 115 may unregister a notification object if a specific time elapses after the notification object is registered.

If an input for reregistering a notification object is received, the object control module 115 may re-designate the corresponding object as a notification object, and change the notification state of the corresponding object to a notification registered state through the object list management module 117. Further, the object control module 115 may display the reregistered notification object in an area of the display 130.

If an input for deleting a notification object is received, the object control module 115 may delete the corresponding object from the object list through the object list management module 117. Further, the object control module 115 may terminate output of the deleted notification object.

The object list management module 117 may manage an object list. The object list management module 117 may register the notification object in the object list if the notification object is selected. When the notification object is registered, the object list management module 117 may store the identifier (e.g., a registered sequence number), the type, the content, and/or the notification state of the object in the object list. The notification state of the object may be classified into a notification registered state and a registration released state (or a notification registration enabled state).

The object list management module 117 may change the notification state of the notification object registered in the object list according to registration of a notification object, release of registration of a notification object, or reregistration of a notification object. For example, if a notification object is registered, the object list management module 117 may set the notification state of the notification object as a notification registration state. Further, the object list management module 117 may change the notification state of the notification object to a notification registration released state (or a notification registration enabled state) if the registration of the notification object is released, and may change the notification state of the notification object to a notification registered state, if the notification of the object is reregistered.

If an input related to deletion of a notification object is made, the object list management module 117 may delete the notification object from the object list. For example, the object list management module 117 may delete information (for example, the identifier, the type, the contents, or the notification state of the object) related to the notification object, from the object list.

The function control module 119 may analyze a user input that is acquired through a function control screen (for example, a quick panel), and may process functions, such as release of registration of a notification object, reregistration of a notification object, or deletion of a notification object (or the notification enabled object), based on the analysis result. The function control screen may be used to change a configuration of functions supported by the electronic device 100, or notify the user of various events (for example, a message reception event, a schedule notification event, or an object notification registration event) (or a control signal) that are generated by the electronic device 100. The function control screen may be displayed on the display 130 in response to a designated user input (e.g., a touch input or a gesture input).

If a notification object is registered, the function control module 119 may display an indication on the function control screen. If an input (for example, an input for selecting a notification object displayed on the function control screen) related to release of registration of a notification object is made, the function control module 119 may change an indication of the notification object to an indication of a notification enabled object on the function control screen. If an input (for example, an input for selecting a notification enabled object displayed on the function control screen) related to reregistration of a notification object is made, the function control module 119 may change an indication of the selected notification enabled object to indicate a notification object on the function control screen. If an input for selecting an object displayed on the function control screen and moving the object in a specific direction is made, the function control module 119 may delete the selected object from the function control screen.

As described above, a portable electronic device may include a memory, a display, and a processor that is electrically connected to the memory and the display. The processor may be configured to acquire a first user input that is related to registration of a notification about an object displayed on the display, register the object as a notification object in response to the first user input, and display the registered notification object in an indicator area, in which states of functions supported by the portable electronic device are displayed, of a screen area of the display.

The processor may be configured to when a second user input for selecting the object is acquired, display a menu that is related to the selected object, on the display, acquire an input for selecting an item, which corresponds to a notification registration function, of items provided in the menu as the first user input, and register the selected object as the notification object in response to the first user input.

The processor may be configured to acquire an input for selecting a button object corresponding to a notification registration function provided in a soft input panel as the first user input, and register the object that is input through the soft input panel as the notification object in response to the first user input.

The processor may be configured to when a second user input for selecting a first item comprising the object is acquired, display a menu that is related to the first item, on the display, acquire an input for selecting an item, which corresponds to a notification registration function, of items included in the menu as the first user input, and register the object included in the first item as the notification object in response to the first user input.

The first item may include an image or a speech bubble that comprises at least one text.

The processor may be configured to store an object list that comprises at least one of an identifier, a type, contents, or a notification state of the notification object, in the memory.

The processor may be configured to in response to a second user input, output a function control screen comprising a first display object corresponding to the notification object, for changing configurations of functions supported by the portable electronic device or informing a user of a control signal generated by the portable electronic device on the display, and in response to a third user input that is input through the function control screen, perform at least one of a notification registration release function, a notification reregistration function, or a deletion function for the notification object.

The processor may be configured to acquire an input for selecting the first display object corresponding to the notification object, as the third user input, in response to the third user input, change the notification object to a notification enabled object and change the first display object corresponding to the notification object to a second display object corresponding to the notification enabled object, and terminate display of the notification object displayed in the indicator area.

The processor may be configured to acquire an input for selecting the second display object corresponding to the notification enabled object, as the third user input, in response to the third user input, change the notification enabled object to the notification object and change the second display object corresponding to the notification enabled object to the first display object corresponding to the notification object, and display the notification object in the indicator area.

The processor may be configured to acquire a user input for selecting at least one of the first display object and the second display object provided on the function control screen as the third user input, delete the selected display object from the function control screen in response to the third user input, and if the selected display object is the first display object corresponding to the notification object, terminate display of the notification object displayed in the indicator area.

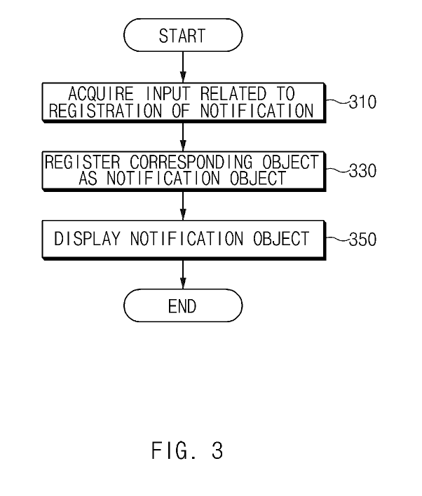

FIG. 3 is a flowchart illustrating a method for displaying a notification object according to an embodiment of the present disclosure.

Referring to FIG. 3, an electronic device receiving an input for registering a notification object in step 310. For example, the electronic device may display a menu related to a selected object, and receive a notification registration input by a user selecting a notification function item included in the menu, or the electronic device may output a menu related to an item including an object on a screen, and receive a notification registration input by a user selecting the notification registration function item included in the menu. The electronic device may also receive a notification registration input by a user selecting a button object that is set to perform a notification registration function.

In step 330, the electronic device registers the corresponding object as a notification object. When a notification registration input (or user input) is received through a menu related to a selected object (e.g., the user select an item corresponding to a notification registration function included in the menu), the electronic device may register the selected object as a notification object, or when a notification registration input is received through a menu related to an item including an object, the electronic device may register an object included in the item as a notification object. When a notification registration input is received through a button object that is set to perform a notification registration function, the electronic device may register an object that is displayed in a display area related to the button object as a notification object.

In step 350, the electronic device displays the notification object, e.g., in an uppermost level layer of the screen, or in an indicator area.

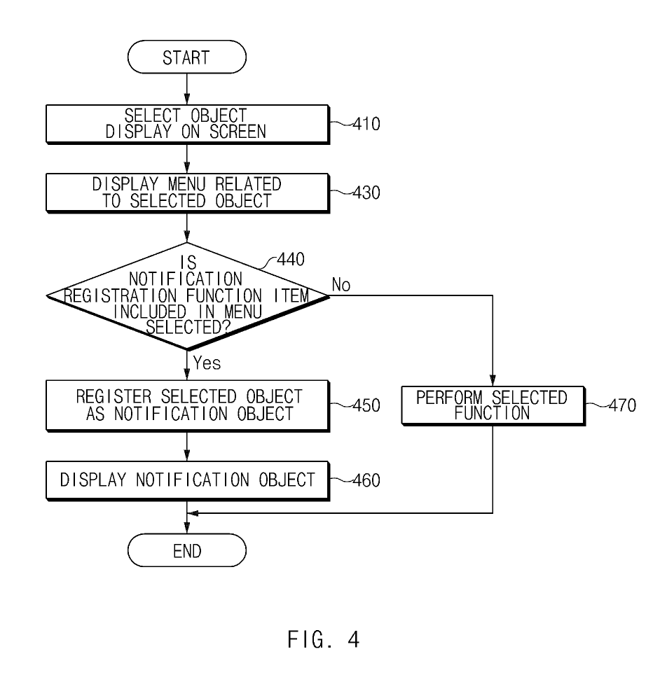

FIG. 4 is a flowchart illustrating a method for displaying a notification through a menu, according to an embodiment of the present disclosure.

Referring to FIG. 4, in step 401, the electronic device receives a user input for selecting a displayed object. The electronic device may display an indication that the object is selected at (or adjacent to) a location at which the input is made.

In step 430, the electronic device displays a menu related to the selected object. For example, when the selected object is text, the electronic device may display a menu including functions for selecting, copying, and/or cutting the text or for registering an item as a notification object.

In step 440, the electronic device determines whether a notification registration function item is selected from the menu.

When the notification registration function item is selected, the electronic device registers the selected object as a notification object in step 450. The electronic device may store information such as an identifier, a type, content, and/or a notification state of the notification object in an object list. Further, the electronic device may set the notification state of the selected object as being in a notification registered state.

In step 460, the electronic device displays the registered notification object, e.g., in an indicator area.

When an item selected from the menu is not a notification registration function item in step 440, the electronic device performs the selected function in step 470. For example, when the selected item for selecting all text (or objects), the electronic device may select all of the text (or objects) displayed on the screen. Further, when the selected item is copy or cut of text (or an object), the electronic device may store the cut or copied text (or the object) in a memory.

When the selected item is copy or cut of text (or an object), the electronic device 100 perform a function that is the same as or similar to selecting a notification registration function item. For example, when the selected item is for copying or cutting text (or an object), the electronic device may perform operations 450 and 460. In this case, the electronic device may perform notifying an object without providing a menu and a button object corresponding to a notification registration function to the user.

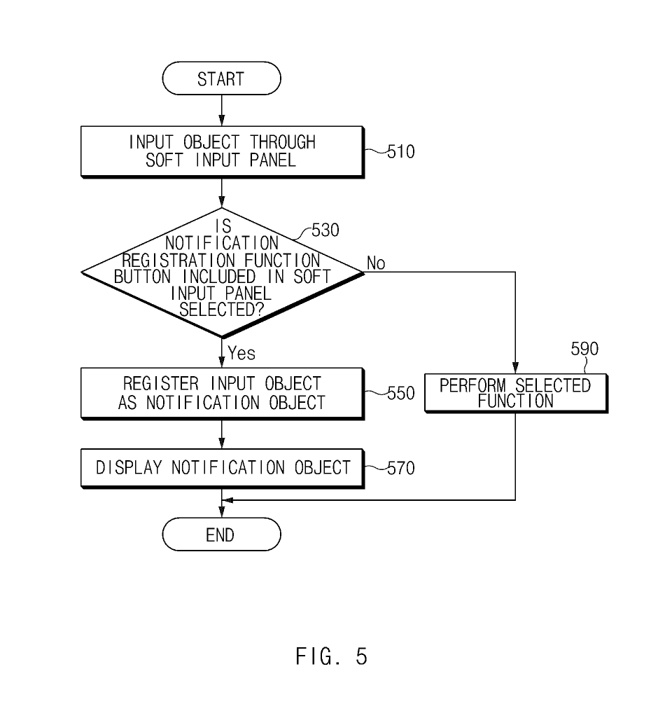

FIG. 5 is a flowchart illustrating a method for displaying a notification through a soft input panel, according to an embodiment of the present disclosure.

Referring to FIG. 5, in step 501, the electronic device receives an object through a soft input panel that provides a user interface for inputting the object, such as text. For example, the soft input panel may function as a virtual keyboard that is implemented in a software way. The soft input panel may include a button object corresponding to the object. For example, if the button object included in the soft input panel is selected, an object corresponding to the selected button object may be input.

In step 530, the electronic device determines whether a notification registration function item button for performing a notification registration function is selected. The notification registration function button may be included in the soft input panel. The notification registration function button may be a physical button, and may be arranged on one surface of the housing of the electronic device.

When the notification registration function button is selected, the object that is input (or is being input) through the soft input panel is registered as a notification object in step 550. The electronic device may register the input object displayed in a display area related to the notification registration function button as a notification object. Further, the electronic device may store information such as the identifier, the type, the contents, or the notification state of the input object in an object list, and may set the notification state of the input object as a notification registered state.

In step 570, the electronic device displays the registered notification object, e.g., in an indicator area.

When the notification registration function button is not selected in step 530, the electronic device performs a selected function in step 590. When another button object included in the soft input panel is selected, the electronic device may perform a function corresponding to the selected button object.

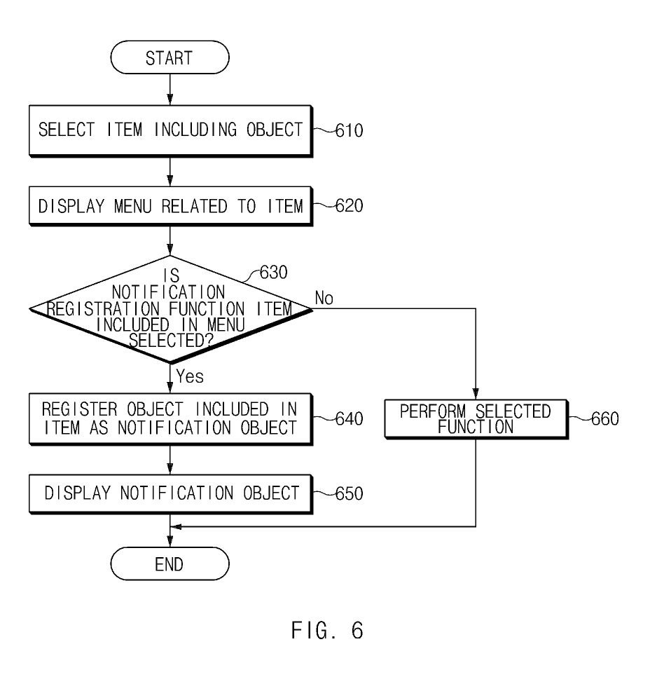

FIG. 6 is a flowchart illustrating a method for displaying a notification object according to an embodiment of the present disclosure.

Referring to FIG. 6, in step 610, an electronic device receives a user input selecting an item including an object. The electronic device may output an execution screen of an application that uses an item including an object (e.g., an image or a speech bubble including text), and may receive the user input for selecting the item from the execution screen of the application.

In step 620, the electronic device displays a menu related to the selected item. For example, the electronic device may display a menu including a function for deleting an item or copying an object included in the item or a notification registration function, or the electronic device may display a menu related to an application that uses the item. For example, the electronic device may display a menu including functions supported by the application and a notification registration function as an item on the screen.

In step 630, the electronic device determines whether a notification registration function item is selected from the menu.

When the notification registration function item is selected in step 630, the electronic device registers the object included in the item as a notification object in step 640.

In step 650, the electronic device displays the registered notification object, e.g., in an indicator area.

When an item selected from the menu is not a notification registration function item in step 630, the electronic device performs the selected function in step 660.

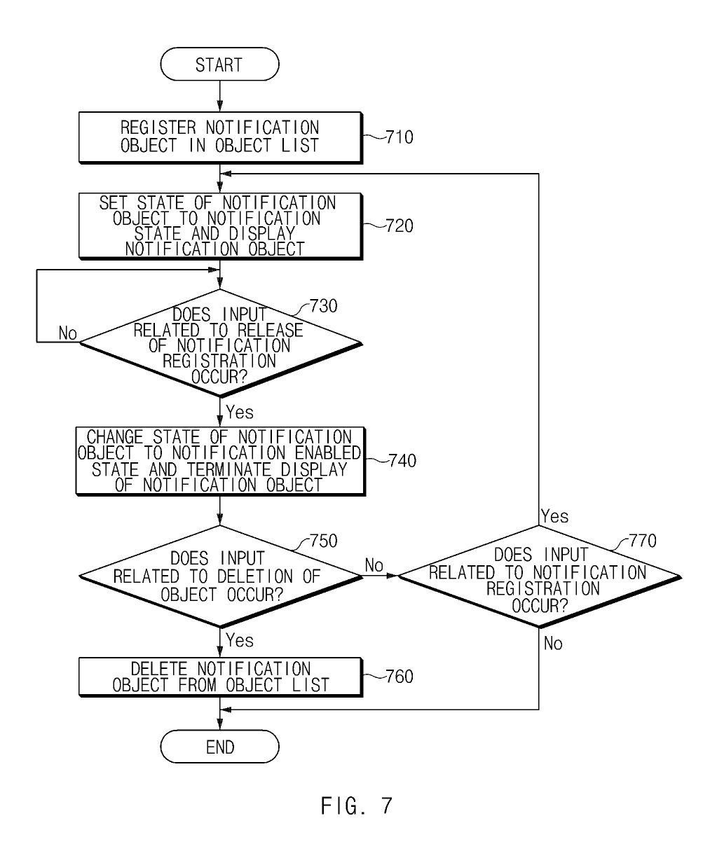

FIG. 7 is a flowchart illustrating a method for managing an object list according to an embodiment of the present disclosure.

Referring to FIG. 7, an electronic device registers a notification object in an object list in step 710. The object list may include information for managing objects that were previously registered as notification objects. For example, the object list may include information such as the identifier, the type, the contents, or the notification state of the object. The electronic device may store the object list in a memory and manage the stored object list.

In step 720, the electronic device sets a notification state of the notification object as being in a notification registration state, and displays the notification object in a specified area, e.g., in an indicator area.

In step 730, the electronic device determines whether an input for releasing the notification registration is received. The electronic device may determine whether an input for selecting a notification object displayed on a function control screen (e.g., a quick panel) is made.

When the input for releasing notification registration is not received in step 730, the method repeats step 730.

When the input for releasing the notification registration is received in step 730, the electronic device performs a notification registration release function in step 740. For example, the electronic device may designate the notification object as a notification enabled object, and may change the notification state of the notification object to a notification registration enabled state. The electronic device may also terminate displaying the notification object.

Alternatively, the electronic device may perform step 740 if a specific time elapses after step 720.

In step 750, the electronic device determines whether an input for deleting the object is received. For example, the input for deleting a notification object or a notification enabled object displayed on the function control screen (e.g., the quick panel) may be a touch and drag input that drags the notification object or notification enabled object in a specific direction.

When the input for deleting the object occurs, the electronic device deletes the selected object from the object list in step 760. The electronic device may delete the information related to the selected object from the object list. For example, the electronic device may delete information, such as the identifier, the type, the contents, or the notification state of the selected object, which is registered in the object list.

When the input for deleting the object does not occur in step 750, the electronic device determines whether an input related to notification reregistration occurs, in step 770. For example, the electronic device may determine whether an input for selecting a notification enabled object displayed on a function control screen (e.g., a quick panel) occurs.

When the input related to notification reregistration occurs, the method returns to step 720 and the electronic device designates the notification enabled object as a notification object, i.e., changes the notification state of the notification enabled object to a notification registered state. The electronic device may display the changed notification registered state in an indication area of the screen.

As described above, an object notification method of a portable electronic device may include acquiring a first user input that is related to registration of a notification about an object displayed on a display, registering the object as a notification object in response to the first user input, and displaying the registered notification object in an indicator area, in which states of functions supported by the portable electronic device are displayed, of a screen area of the display.

The object notification method may further include when a second user input for selecting the object is acquired, displaying a menu that is related to the selected object, on the display. The acquiring of the first user input may include acquiring an input for selecting an item, which corresponds to a notification registration function, of items included in the menu as the first user input. The registering of the object may include registering the selected object as the notification object.

The acquiring of the first user input may include acquiring an input for selecting a button object corresponding to a notification registration function provided in a soft input panel as the first user input. The registering of the object may include registering the object input through the soft input panel as the notification object.

The object notification method may further include if a second user input for selecting a first item comprising the object is acquired, displaying a menu that is related to the first item, on the display. The acquiring of the first user input may include acquiring an input for selecting a second item, which corresponds to a notification registration function, of items included in the menu as the first user input. The registering of the object may include registering the object included in the first item as the notification object.

The object notification method may further include storing an object list that comprises at least one of an identifier, a type, contents, or a notification state of the notification object, in the memory.

The object notification method may further include outputting a function control screen for, in response to a second user input, changing configurations of functions comprising a first display object corresponding to the notification object and supported by the portable electronic device or informing a user of a control signal generated by the portable electronic device, on the display, and in response to a third user input that is input through the function control screen, performing at least one of a notification registration release function, a notification reregistration function, or a deletion function for the notification object.

The performing of the at least one of the notification registration release function, the notification reregistration function, or the deletion function for the notification object may include acquiring an input for selecting the first display object corresponding to the notification object, as the third user input, in response to the third user input, changing the notification object to a notification enabled object and changing the first display object corresponding to the notification object to a second display object corresponding to the notification enabled object, and terminating display of the notification object displayed in the indicator area.

The performing of the at least one of the notification registration release function, the notification reregistration function, or the deletion function for the notification object may include acquiring an input for selecting the second display object corresponding to the notification enabled object, as the third user input, and in response to the third user input, changing the notification enabled object to the notification object and changing the second display object corresponding to the notification enabled object to the first display object corresponding to the notification object, and displaying the notification object in the indicator area.

The performing of the at least one of the notification registration release function, the notification reregistration function, or the deletion function for the notification object may include acquiring a user input for selecting at least one of the first display object and the second display object provided on the function control screen as the third user input, and deleting the selected display object from the function control screen in response to the third user input, and if the selected display object is the first display object corresponding to the notification object, terminating display of the notification object displayed in the indicator area.

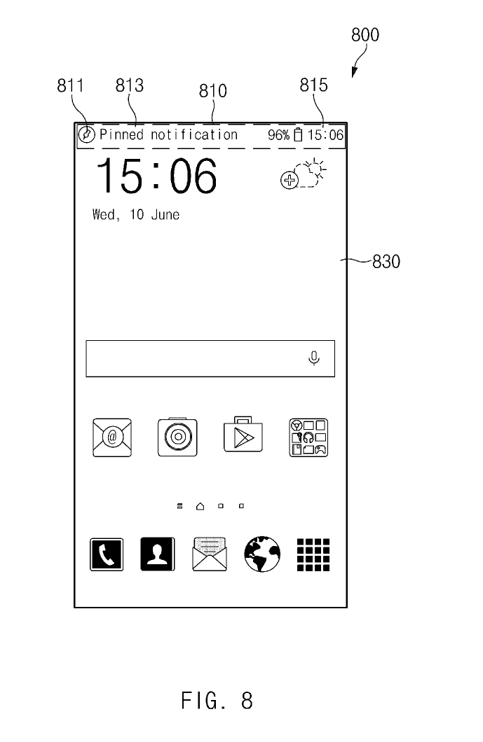

FIG. 8 illustrates a screen displaying a notification object according to an embodiment of the present disclosure.

Referring to FIG. 8, a screen 800 includes an indicator area 810 in which states of functions supported by an electronic device are displayed, and an execution area 830 for a currently performed function.

The execution area 830 may output an execution screen of an application. In FIG. 8, an execution screen of a home application is output in the execution area 830. Content (i.e., text, images, and icons) corresponding to the home application are displayed in the execution area 830.

A display object 815 (i.e., a battery state and the time) are displayed in the indicator area 810. Additionally, a pin-shaped image 811 and text (e.g., a pinned notification) corresponding to the notification object are displayed as the content 813 of the notification object.

The indicator area 810 is an uppermost level layer of the screen 800, and occupies an upper end area of the screen 800. Accordingly, even when the screen output in the execution area 830 is changed, the indicator area 810 may maintain an output state.

If the performed function is changed, e.g., a new application is executed, the screen displayed in the execution area 830 may change.

The electronic device may alternately display at least one of the pin-shaped image 811, the content 813, and the display object 815 at specific time intervals. Further, the electronic device may display at least one of the pin-shaped image 811 or the content 813 in an area of the indicator area 810 that is not occupied by the display object 815.

When the at least one of the pin-shaped image 811 or the content 813 is alternately displayed, the electronic device may control the alternate displaying, based on a default time or a time set by the user input.

The content 813 may be sequentially displayed (e.g., in a page manner or in a sliding manner) at a specific speed.

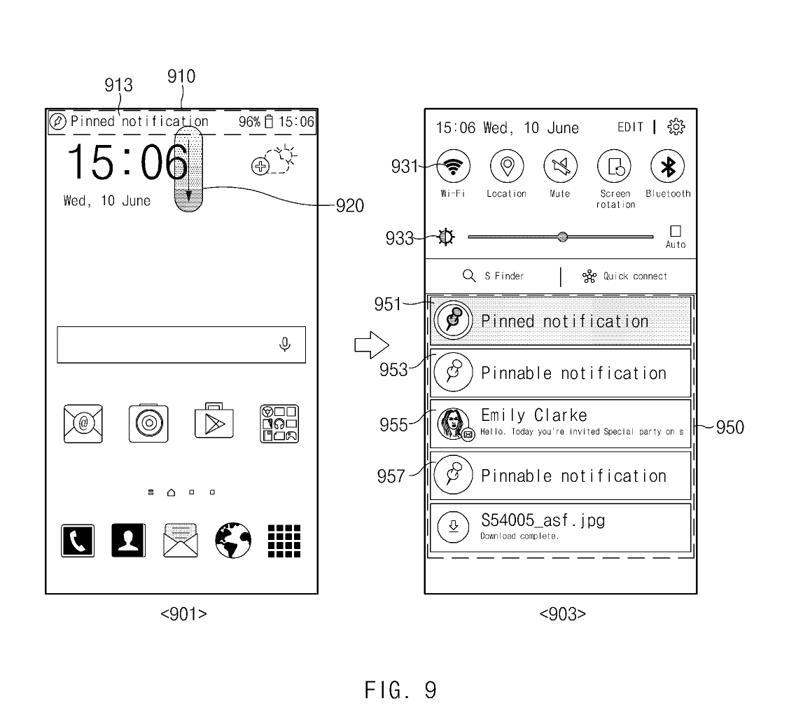

FIG. 9 illustrates screens for notification object management according to an embodiment of the present disclosure.

Referring to FIG. 9, a first screen 901 includes an indicator area 910 that displays a notification object 913.

The electronic device displays a second screen 903, in response to user input 920 on the first screen 901, which selects the indicator area 910 and moves the selected indicator area 910 towards a lower end of the screen. The electronic device steps displaying the indicator area 910 in the second screen 903, when the function control screen is displayed.

The function control screen includes a display object (e.g., text, an image, or an icon) that is configured to change configurations of the functions supported by the electronic device, and a display object that is configured to inform the user of various events (e.g., a message reception event, a notification event, or an object notification registration event) that are generated by the electronic device. The function control screen includes a communication configuration icon 931, and a brightness level adjusting slide bar 933. Further, the function control screen includes a notification object display button 951, notification enabled object display buttons 953 and 957, and a received message display button 955.

If a specific user input is made, the display object configured to inform the user of various events may be deleted from the display area 950. If an input for selecting the received message display button 955 is made, the electronic device may delete the received message display button 955 from the display area 950, execute the message application to display the received message, and display the execution screen of the message application.

If an input for selecting the notification object display button 951 or the notification enabled object display button 953 or 957 and moving the selected button in a specific direction (e.g., to the left or right side of the screen 903) is made, the electronic device may delete the selected display button from the display area 950.

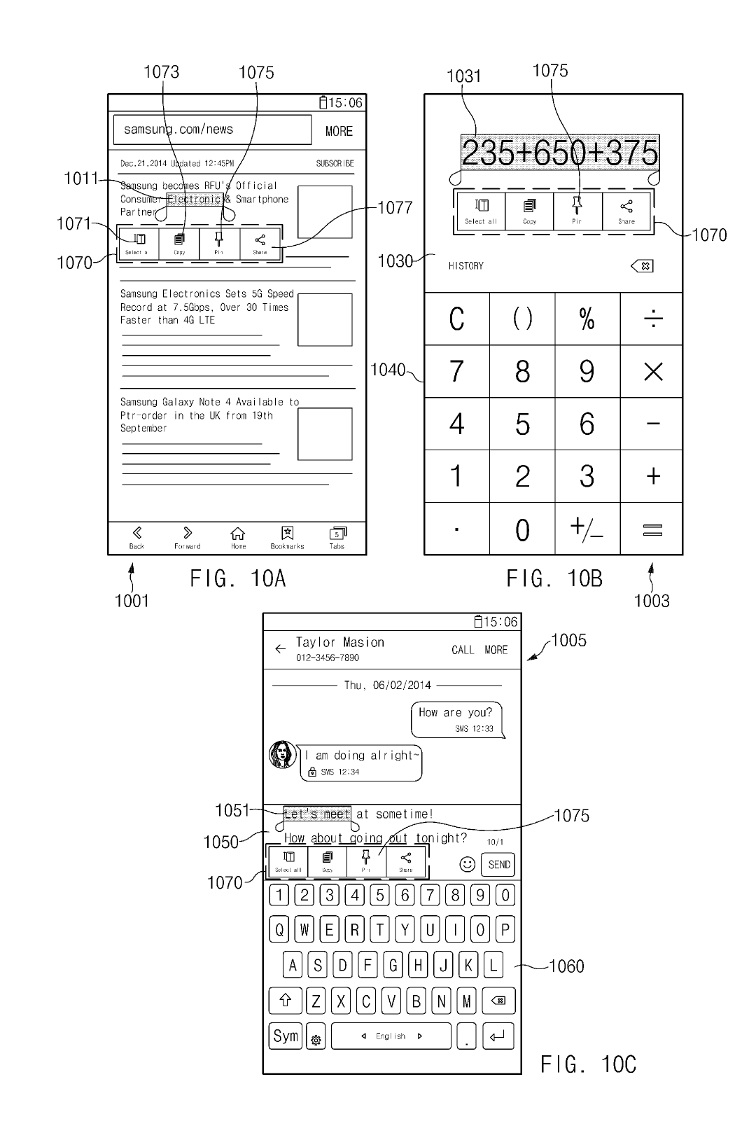

FIG. 10A illustrates an execution screen of a web search application for registering a notification object through a menu according to an embodiment of the present disclosure.

Referring to FIG. 10A, the electronic device displays an execution screen 1001 of a web search application (or a web browser), which includes at least one object (for example, a text or an image).

If an input for starting selection of an object displayed on the screen 1001 is made (e.g., a long press input is made at or around the object, the electronic device outputs a display object indicating that the selection of the object at (or adjacent to) the location at which the input is made. Further, if the display object is selected and moved (for example, dragged) in a specific direction, the electronic device designates an object displayed within a movement range of the display object on the screen as a selected object 1011. In this case, as illustrated, the electronic device highlights the selected object 1011.

If an object displayed on the screen 1001 is designated as the selected object 1011, the electronic device displays a popup menu 1070 related to the selected object 1011 at a location at which the selected object 1011 is displayed or at a location that is adjacent to the display location.

The menu 1070 includes a select all function button 1071, a copy function button 1073, a notification registration function button 1075, and a sharing function button 1077. In addition, the menu 1070 may include a cut function button, a web search function button, a dictionary search function button, a translation function button, etc.

If the menu 1070 includes more items than can be displayed at one time, a touch input sliding the menu items to the right or the left may scroll the menu to display addition menu items.

If the notification registration function button 1075 in the menu 1070 is selected, is the electronic device may register the selected object 1011 as a notification object. Selection of the copy function button 1073 or the cut function button in the menu 1070 may also register the selected object 1011 as a notification object.

When an item included in the menu 1070 is selected or another area of the screen 1001, other than the menu 1070, is selected, the electronic device may release the selection of the selected object 1011 and stop displaying the menu 1070. In this case, the electronic device may stop highlighting the selected object 1011.

FIG. 10B illustrates a calculator application screen for registering a notification object through a menu according to an embodiment of the present disclosure.

Referring to FIG. 10B, the electronic device may register a notification object through the menu 1070 in an execution screen 1003 of the calculator application, in a manner that is the same as or similar to the execution screen 1001 of the web search application. For example, a button corresponding to a number, a letter, or a symbol included in a calculation input area 1040 is selected, and an object corresponding to the number, the letter, or the symbol is displayed in a calculation display area 1030 according to the corresponding button. Further, the electronic device outputs a menu 1070 related to the selected object 1031, if at least one of the objects displayed in the calculation display area 1030 is selected, and registers the selected object 1031 as a notification object, if a notification registration function button 1075 in the menu 1070 is selected.

FIG. 10C illustrates a message application screen for registering a notification object through a menu according to an embodiment of the present disclosure.

Referring to FIG. 10C, the electronic device registers a notification object through the menu 1070 in an execution screen 1005 of the message application. For example, if an object is input through the soft input panel 1060, the electronic device outputs the input object in the display area 1050. Further, the electronic device outputs the menu 1070 related to the selected object 1051, if at least one of the objects displayed in the display area 1050 is selected, and registers the selected object 1051 as a notification object, if a notification registration function button 1075 in the menu 1070 is selected.

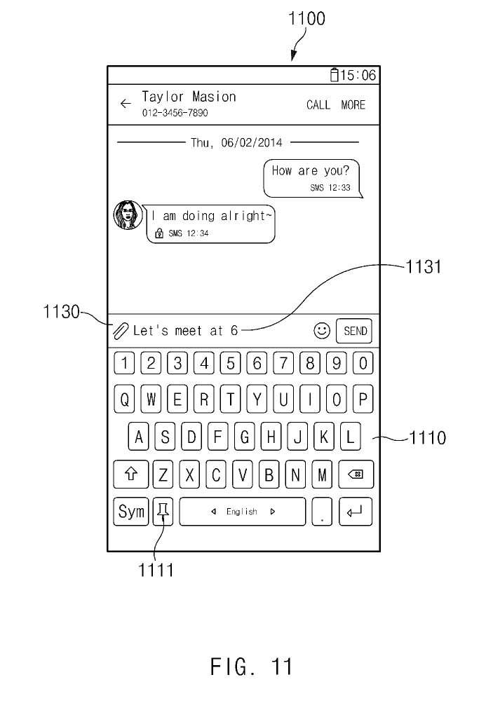

FIG. 11 illustrates a screen for registering a notification object through a soft input panel according to an embodiment of the present disclosure.

Referring to FIG. 11, the electronic device displays an execution screen 1100 of a message application. The execution screen 1100 of the message application includes an area in which a transmitted or received message is displayed, and a display area 1130 of a message that is to be transmitted. If an input for selecting the display area 1130 is made, the electronic device 100 may output the soft input panel 1110.

The soft input panel 1110 includes a button object corresponding to an object, such that the object may be input. Accordingly, if the button object included in the soft input panel 1110 is selected, the electronic device may display an object corresponding to the selected button object in the display area 1130.

The soft input panel 1110 includes a notification registration function button 1111, which when selected, instructs the electronic device to register the object 1131 in the display area 1130 as a notification object.

Although FIG. 11 illustrates registration of a notification through the soft input panel 1110 output on the execution screen 1100 of the message application, the present disclosure is not limited thereto. The soft input panel 1110 may perform a notification registration function in the same or similar manner even in an execution screen of another application that uses the soft input panel 1110. For example, the electronic device may perform a notification registration function through the soft input panel 1110 on an execution screen of the web search application.

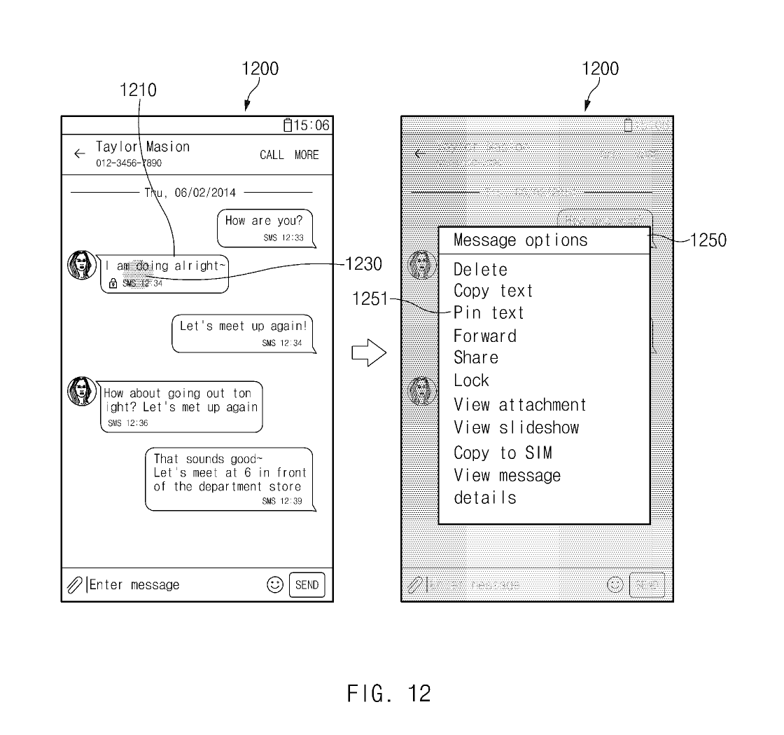

FIG. 12 illustrates screen for registering a notification object according to an embodiment of the present disclosure.

Referring to FIG. 12, the electronic device displays an execution screen 1200 of a message application, which includes transmitted and received messages. The transmitted and received message may be selected as an object.

More specifically, if a designated user input 1230 for the message 1210 is received, the electronic device outputs a menu 1250 related to the message 1210 on the screen 1200. Although FIG. 12 illustrates that the electronic device outputs the menu 1250 as a popup and the execution screen 1200 of the message application is dimmed, the present disclosure is not limited thereto. For example, the electronic device may display the menu 1250 on the entire screen, and/or may not dim the execution screen 1200 of the message application.

The menu 1250 includes a function for deleting the message 1210, a function of copying an object, e.g., text, included in the message 1210, and a notification registration function.

The electronic device may also include an item related to the message application that uses the message 1210 in the menu 1250. For example, the menu 1250 includes a message sharing function, a message locking function, an attached file display function, and a message storing function supported by the message application.

If a notification registration function item 1251 is selected from the menu 1250, the electronic device may register an object included in the message 1210 as a notification object, i.e., the electronic device may register the text included in a speech bubble of message 1210 as a notification object.

Although FIG. 12 illustrates registration of a notification through the message, i.e., item, 1210 including the object displayed on the execution screen 1200 of the message application, the present disclosure is not limited thereto. The electronic device may perform a notification registration function in the same or similar manner even in an execution screen of another application that outputs the item 1210 including the object. For example, the electronic device may register text included in a picture as a notification object in the same or similar manner in an execution screen of an album application that outputs the picture.

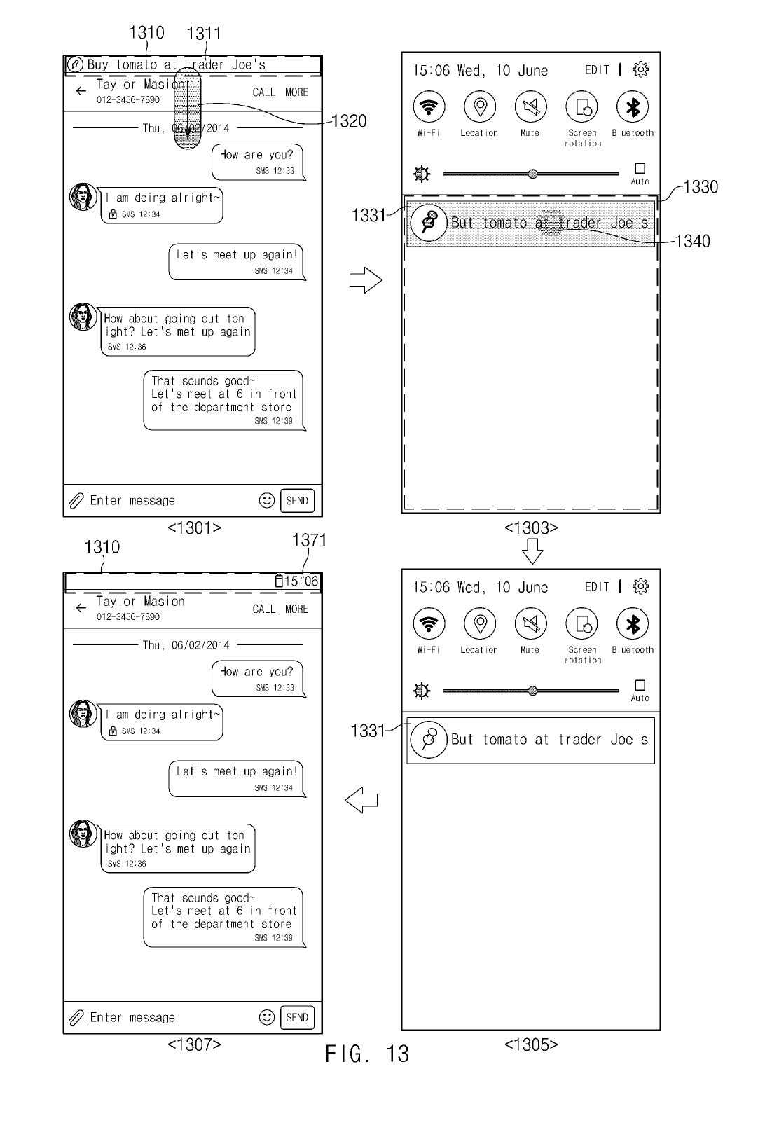

FIG. 13 illustrates screens for unregistering a notification object according to an embodiment of the present disclosure.

Referring to FIG. 13, the electronic device displays an execution screen of an application on a screen 1301, which includes an indicator area 1310 for displaying a notification object 1311.

In response to a designated user input 1320, the electronic device outputs a function control screen (e.g., a quick panel) in screen 1303. The function control screen displays a notification object display button 1331 corresponding to the notification object 1311 in a display area 1330.

In response to an input 1340 for selecting the notification object display button 1331, related to release of registration of a notification, the electronic device designates the notification object 1311 as a notification enabled object and stops displaying of the notification object 1311. Specifically, in screen 1305, the electronic device changes the notification object display button 1331 to a notification enabled object display button 1331, e.g., by changing an image and color of the notification object display button 1331, and in screen 1307, the electronic device stops displaying of the notification object 1311 and displays a display object 1371 in the indicator area 1310.

The electronic device may change the notification object display button 1331 to the notification enabled object display button 1331 by changing a display state of the notification object display button 1331. For example, the electronic device may change an image included in the notification object display button 1331, may change the color or the peripheral shape of the notification object display button 1331, or may change the color or the thickness of a text included in the notification object display button 1331.

Alternatively, if the input 1340 for selecting the notification object display button 1331 in screen 1303 is input, the electronic device may display screen 1307, without displaying screen 1305.

Further, a designated user input may be made in the screen 1305, to control the electronic device to display the screen 1307. For example, the designated user input may be a swipe of screen 1305 to the left or the right.

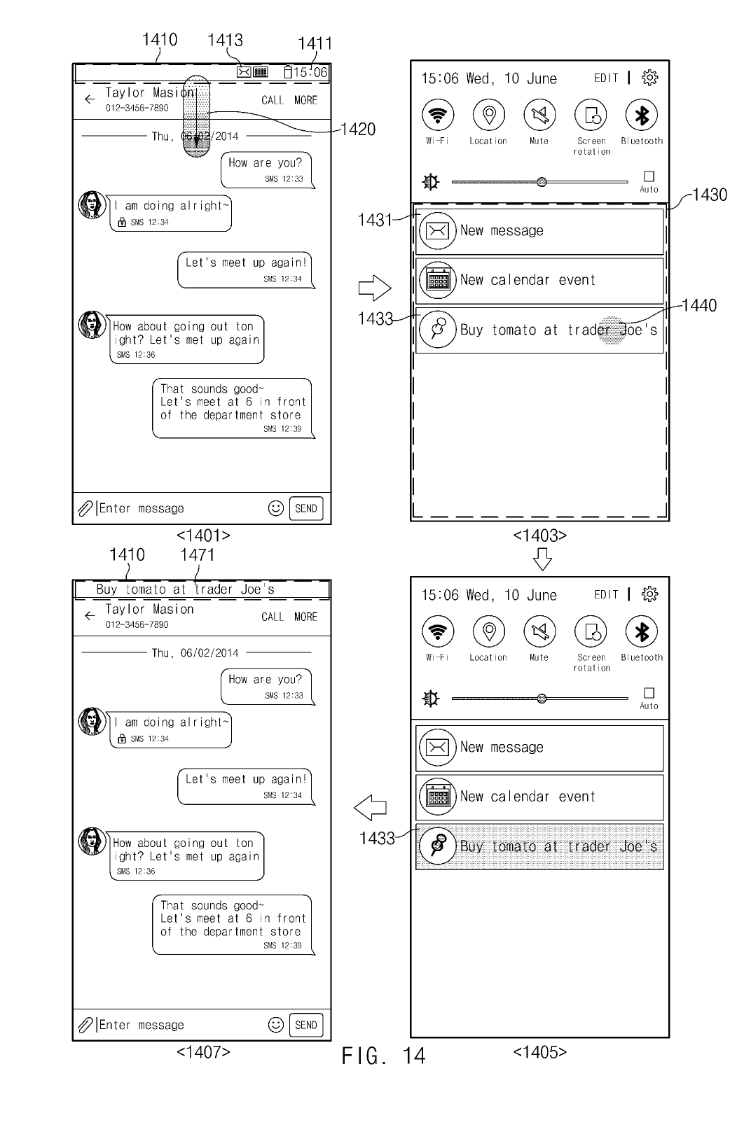

FIG. 14 illustrates screens for reregistering a notification object according to an embodiment of the present disclosure.

Referring to FIG. 14, the electronic device outputs an execution screen of an application on screen 1401. Screen 1401 includes an indicator area 1410, which includes a display object 1411 and a letter-shaped image 1413 corresponding to a message reception event.

In response to a designated user input 1420, the electronic device displays a function control screen in screen 1403. The function control screen includes a received message display button 1431 and a notification enabled object display button 1433 in a display area 1430.

In response to an input 1440 for selecting the notification enabled object display button 1433, related to reregistration of a notification, the electronic device designates the notification enabled object as a notification object and displays the notification object 1471 in the indicator area 1410 of screen 1407. More specifically, in screen 1405, the electronic device changes the notification enabled object display button 1433 to a notification object display button 1433. Further, in screen 1407, the electronic device displays the notification object 1471 in the indicator area 1410. In this case, the electronic device terminates the displaying of the display object 1411 and the letter-shaped image 1413. Alternatively, the electronic device may alternately output the objects that have already been output in the indicator area 1410 and a notification object 1471, or may section off the indicator area 1410 such that the objects do not overlap each other.

The electronic device changes the notification enabled object display button 1433 to the notification object display button 1433 by changing the display state of the notification enabled object display button 1433. For example, the electronic device may change the notification enabled object display button 1433 into the notification object display button 1433 by changing an image included in the notification enabled object display button 1433, changing the color or the peripheral shape of the notification enabled object display button 1433, or changing the color or the thickness of a text included in the notification enabled object display button 1433.

Alternatively, if the input 1440 for selecting the notification enabled object display button 1433 in screen 1403 is made, the electronic device may display screen 1407, without first displaying screen 1405.

Further, the electronic device may convert from screen 1305 to screen 1407, in response to a designated user input being made in the screen 1405.

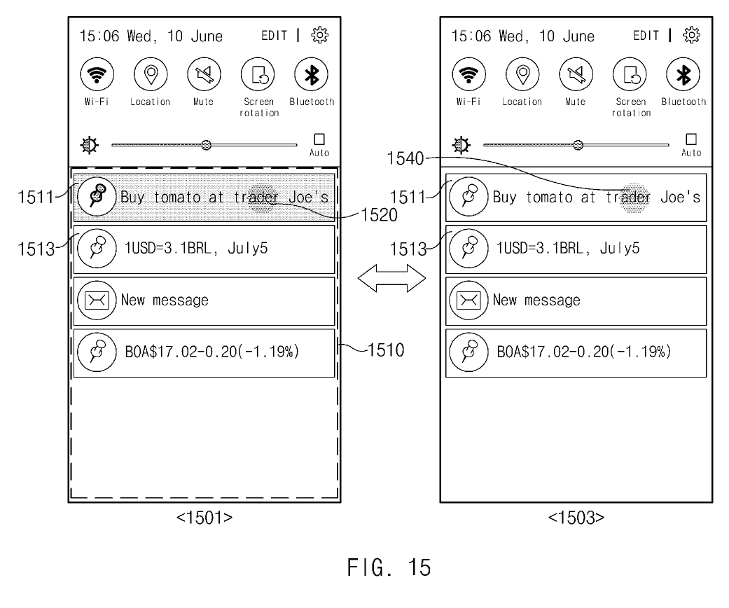

FIG. 15 illustrates screens for reregistering a notification object and for unregistering a notification object according to an embodiment of the present disclosure.

Referring to FIG. 15, in screen 1501, the electronic device displays a function control screen including a first notification object display button 1511 and a second notification enabled object display button 1513 in a display area 1510. If an input 1520 for selecting the first notification object display button 1511 is made, related to release of registration of the notification, the electronic device changes the first notification object display button 1511 to the first notification enabled object display button 1511 as in screen 1511. Further, if an input 1540 for selecting the first notification enabled object display button 1511 is made in screen 1503, related to reregistration of the notification, the electronic device changes the first notification enabled object display button 1511 back to the first notification object display button 1511 in screen 1501.

Similarly, the electronic device may change a second notification enabled object display button 1513 to the second notification object display button 1513 to display the changed second notification object display button 1513.

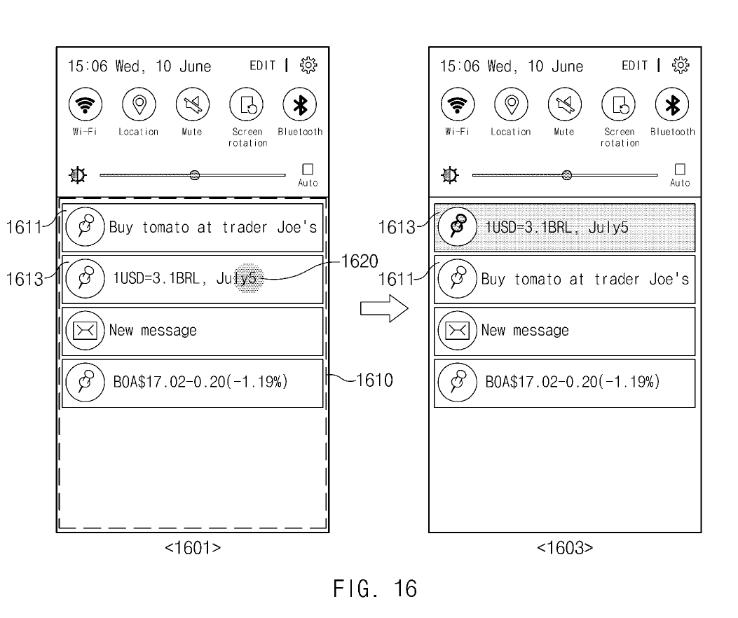

FIG. 16 illustrates screens for arranging an object list according to an embodiment of the present disclosure.

Referring to FIG. 16, in screen 1601, the electronic device displays a function control screen including a first notification enabled object display button 1611 and a second notification enabled object display button 1613 in a display area 1610. For example, the electronic device may arrange the display objects in the display area 1610 based on a time at which the display objects were generated, e.g., a newest display object is listed first or last.

Additionally, if an input 1620 for selecting the second notification enabled object display button 1613 is generated in the screen 1601, the electronic device changes the second notification enabled object display button 1613 to a notification object display button 1613 and displays the notification object display button 1613 at an uppermost end of the display area 1610 in the screen 1603. Accordingly, the electronic device 100 displays the first notification enabled display button 1611 below the notification object display button 1613 in screen 1603.

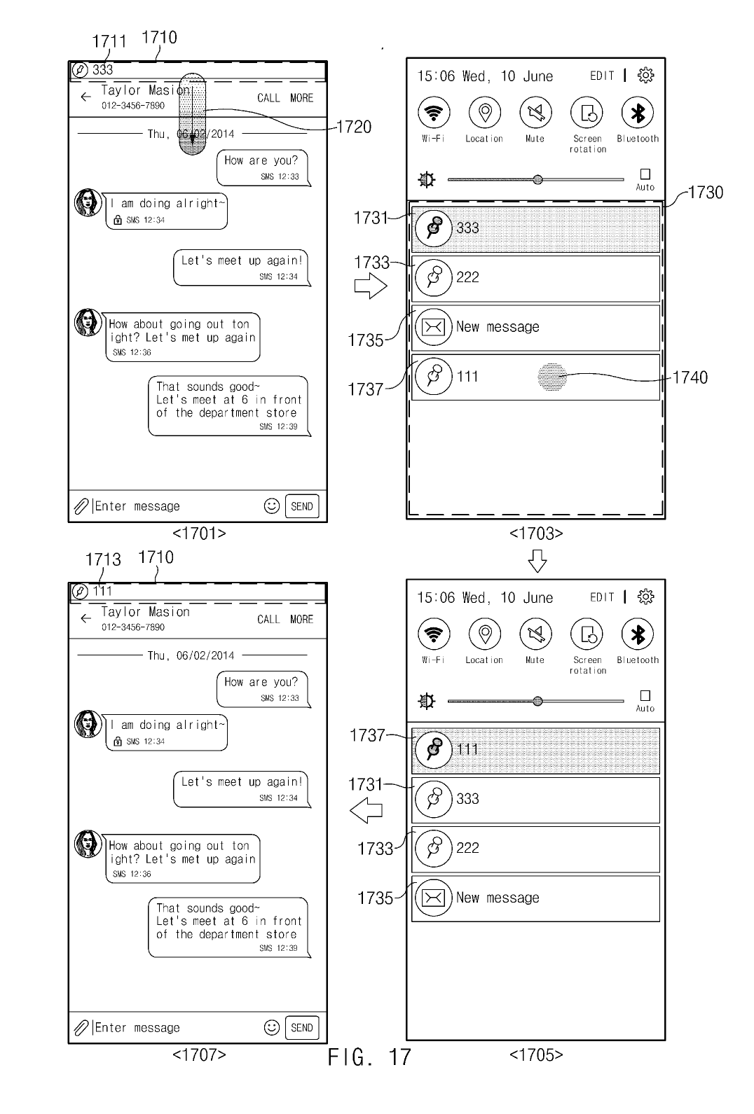

FIG. 17 illustrates screens for registering a notification of another object according to an embodiment of the present disclosure.

Referring to FIG. 17, the electronic device outputs an execution screen of an application on a screen in screen 1701, which includes an indicator area 1710 including a first notification object 1711.

If a designated user input 1720 is made in screen 1701, the electronic device outputs a function control screen including a first notification object display button 1731, a second notification enabled object display button 1733, a received message display button 1735, and a third notification enabled object display button 1737 in a display area 1730 in screen 1703.

If an object that is different from a first notification object 1711, e.g., object 1733, 1735, or 1737, is designated as a notification object while registration of the first notification object 1711 is not released, the electronic device changes the first notification object 1711 to a first notification enabled object.

More specifically, if an input 1740 for selecting a third notification enabled object display button 1737 is made in screen 1703, the electronic device changes the third notification enabled object display button 1737 to a third notification object display button 1737 and changes the first notification object display button 1731 to a first notification enabled object display button 1731 in screen 1705. Accordingly, in response to a newly generated object notification registration event, the electronic device displays the third notification object display button 1737 at an uppermost end of the display area 1730 and sequentially displays the other display objects below the third notification object display button 1737.

Further, the electronic device 100 stops displaying the first notification object 1711 in the indicator area 1710 and displays a newly designated notification object 1713 in the indicator area 1710, in screen 1707.

Alternatively, if an object that is different from a first notification object 1711 is designated as a notification object while registration of the first notification object 1711 is not released, the electronic device may alternately output the first notification object 1711 and the newly designated notification object 1713 at specific time intervals. For example, the electronic device may repeatedly display the first notification object 1711 for a first time period, and display the newly designated notification object 1713 for a second time period.

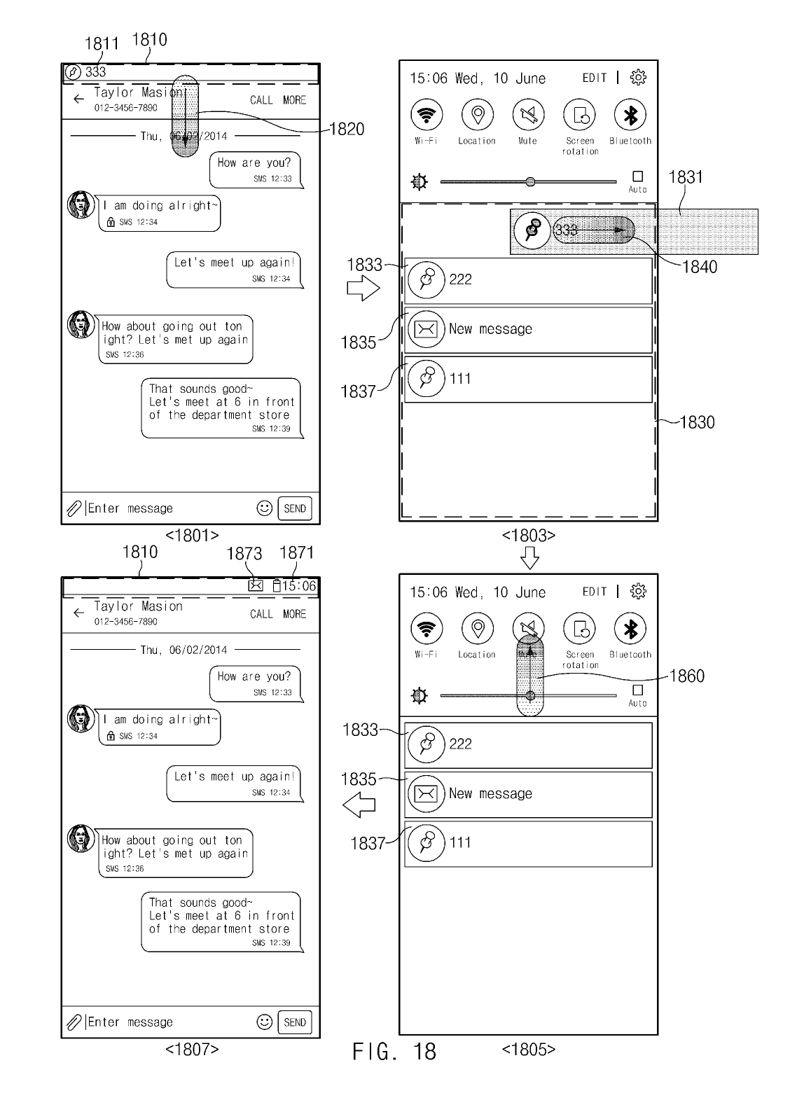

FIG. 18 illustrates screens for deleting a notification object according to an embodiment of the present disclosure.

Referring to FIG. 18, the electronic device outputs an execution screen of an application on a screen 1801, which includes an indicator area 1810 including a notification object 1811.

If a designated user input 1820 is made, the electronic device outputs a function control screen including a first notification object display button 1831, a second notification enabled object display button 1833, a received message display button 1835, and a third notification enabled object display button 1837 in a display area 1830 in a screen 1803.

If an input, which is related deleting an object, is made, the electronic device deletes the corresponding object. Further, if the corresponding object is a notification object, the electronic device stops displaying the object in the indicator area 1810.

More specifically, if an input 1840 that selects the first notification object display button 1831 and moves the selected first notification object display button 1831 to right side of screen 1803 is received, the electronic device deletes the first notification object display button 1831 from the display area 1830 as in screen 1805. Further, in screen 1807, the electronic device no longer displays the notification object 1811 corresponding to the first notification object display button 1831 in the indicator area 1810. Instead, the electronic device displays a display object 1871 and a letter-shaped image 1873in the indicator area 1810.

When the display object included in the display area 1830 is deleted, the electronic device may maintain the output of the function control screen, until an input 1860 is made. Thereafter, the electronic device displays the screen 1807.

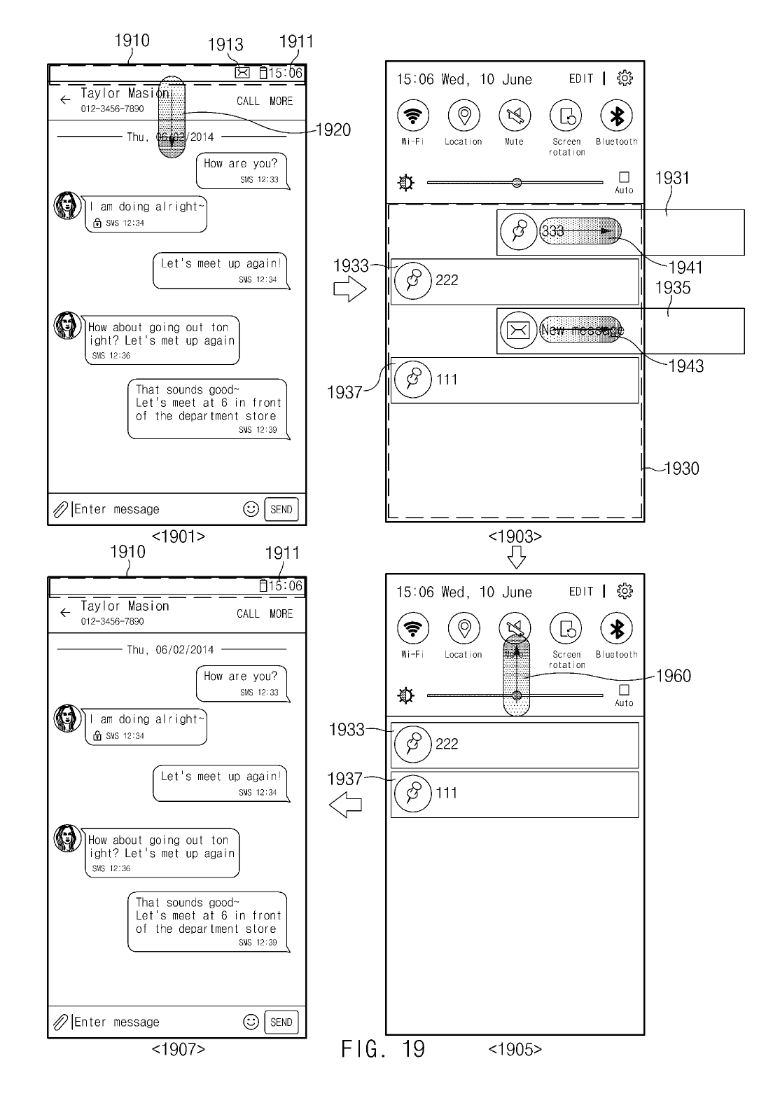

Although FIG. 19 illustrates that the electronic device deleting the notification object display button 1831 from the display area 1830, the present disclosure is not limited thereto. For example, the electronic device 100 may also or alternatively delete the second notification enabled object display button 1833, the third notification enabled object display button 1837, or the received message display button 1835 from the display area 1830.

FIG. 19 illustrates screens for deleting a plurality of notification objects according to an embodiment of the present disclosure.

Referring to FIG. 19, the electronic device outputs an execution screen of an application on a screen 1901, which includes an indicator area 1910 including a display object 1911 and a letter-shaped image 1913.

If a designated user input 1920 is made in screen 1901, the electronic device displays a function control screen including a first notification enabled object display button 1931, a second notification enabled object display button 1933, a received message display button 1935, and a third notification enabled object display button 1937 in a display area 1930 in screen 1903.

If inputs for deleting a plurality of objects are made at the same time or continuously, the electronic device may delete the corresponding objects from the object list. Further, when the corresponding object is a notification object or a display object corresponding to another event displayed in an indicator area 1910, the electronic device stop displaying the corresponding object.

More specifically, if an input 1941, which selects the first notification enabled object display button 1931 and moves the selected first notification enabled object display button 1931 to the right side of the display area 1930, and an input 1943, which selects the received message display button 1935 and moves the selected received message display button 1935 to the right side of the display area 1930, are made, either at the same time or continuously, i.e., within a predetermined time of each other, the electronic device deletes the first notification enabled object display button 1931 and the received message display button 1935 from the display area 1930 in screen 1905. Further, in screen 1907, the electronic device stops displaying the letter-shaped image 1913 corresponding to the received message display button 1935.

When the display object included in the display area 1930 is deleted, the electronic device may maintain the output of the function control screen in screen 1905. until an input 1960 is received. Thereafter, the electronic device displays the screen 1907.

Although FIG. 19 illustrates the electronic device deleting the first notification enabled object display button 1931 and the received message display button 1935 from the display area 1930, the present disclosure is not limited thereto. For example, the electronic device may delete at least one of a notification object display button, a notification enabled object display button, or a display object corresponding to another event from the display area 1930.

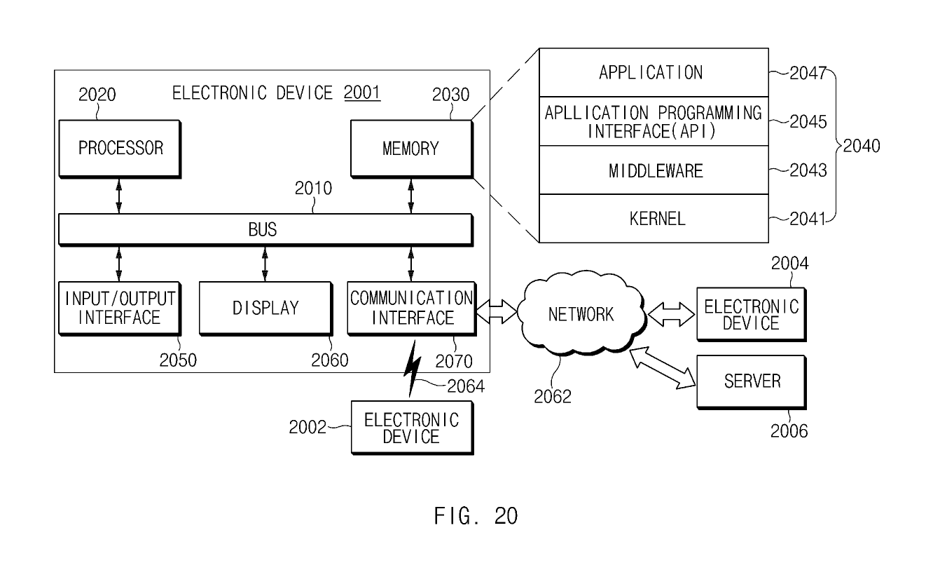

FIG. 20 illustrates an electronic device in a network environment according to an embodiment of the present disclosure.

Referring to FIG. 20, an electronic device 2001 includes a bus 2010, a processor 2020, a memory 2030, an input/output interface 2050, a display 2060, and a communication interface 2070. Alternatively, at least one of the foregoing elements may be omitted and/or another element may be added to the electronic device 2001.

The bus 2010 may include a circuit for connecting the above-mentioned elements 2010 to 2070 to each other and transferring communications (e.g., control messages and/or data) among the above-mentioned elements.

The processor 2020 may include at least one of a CPU, an AP, or a communication processor (CP). The processor 2020 may perform data processing or an operation related to communication and/or control of at least one of the other elements of the electronic device 2001.

The memory 2030 may include a volatile memory and/or a nonvolatile memory. The memory 2030 may store instructions or data related to at least one of the other elements of the electronic device 2001. The memory 2030 may store software and/or a program 2040. The program 2040 includes a kernel 2041, a middleware 2043, an application programming interface (API) 2045, and an application program (or an application) 2047. At least a portion of the kernel 2041, the middleware 2043, or the API 2045 may be referred to as an OS.

The kernel 2041 may control or manage system resources (e.g., the bus 2010, the processor 2020, the memory 2030, etc.) used to perform operations or functions of other programs (e.g., the middleware 2043, the API 2045, or the application program 2047). Further, the kernel 2041 may provide an interface for the middleware 2043, the API 2045, or the application program 2047 to access individual elements of the electronic device 2001, e.g., in order to control or manage the system resources.

The middleware 2043 may serve as an intermediary for the API 2045 or the application program 2047 to communicate and exchange data with the kernel 2041.

The middleware 2043 may handle one or more task requests received from the application program 2047 according to a priority order. For example, the middleware 2043 may assign the application program 2047 a priority for using the system resources of the electronic device 2001. The middleware 2043 may handle the one or more task requests according to the priority assigned to the at least one application, thereby performing scheduling or load balancing with respect to the one or more task requests.

The API 2045, which is an interface for allowing the application 2047 to control a function provided by the kernel 2041 or the middleware 2043, may include at least one interface or function (e.g., instructions) for file control, window control, image processing, character control, etc.

The input/output interface 2050 may serve to transfer an instruction or data input from a user or another external device to another element of the electronic device 2001. The input/output interface 2050 may output instructions or data received from another element of the electronic device 2001 to the user or another external device.

The display 2060 may include a liquid crystal display (LCD), a light-emitting diode (LED) display, an organic light-emitting diode (OLED) display, a microelectromechanical systems (MEMS) display, and/or an electronic paper display. The display 2060 may present various content to the user. The display 2060 may include a touch screen, and may receive a touch, gesture, proximity, and/or hovering input from an electronic pen or a part of a body of the user.

The communication interface 2070 may set communications between the electronic device 2001 and a first external electronic device 2002, a second external electronic device 2004, and/or a server 2006. For example, the communication interface 2070 may be connected to a network 2062 via wireless communications or wired communications so as to communicate with the second external electronic device 2004 or the server 2006.

The wireless communications may employ at least one of cellular communication protocols such as long-term evolution (LTE), LTE-advance (LTE-A), code division multiple access (CDMA), wideband CDMA (WCDMA), universal mobile telecommunications system (UMTS), wireless broadband (WiBro), or global system for mobile communications (GSM). The wireless communications may include a short-range communications 2064, such as wireless fidelity (Wi-Fi), Bluetooth, near field communication (NFC), magnetic stripe transmission (MST), or GNSS.

The MST may generate pulses according to transmission data and the pulses may generate electromagnetic signals. The electronic device 2001 may transmit the electromagnetic signals to a reader device such as a POS device, which may detect the magnetic signals by using an MST reader and restore data by converting the detected electromagnetic signals into electrical signals.

The GNSS may include at least one of global positioning system (GPS), global navigation satellite system (GLONASS), BeiDou navigation satellite system (BeiDou), or Galileo, the European global satellite-based navigation system.

The wired communications may include at least one of universal serial bus (USB), high definition multimedia interface (HDMI), recommended standard 832 (RS-232), plain old telephone service (POTS), etc.

The network 2062 may include at least one of telecommunications networks, for example, a computer network (e.g., local area network (LAN) or wide area network (WAN)), the Internet, or a telephone network.

The types of the first external electronic device 2002 and the second external electronic device 2004 may be the same as or different from the type of the electronic device 2001.

The server 2006 may include a group of one or more servers.

A portion or all of operations performed in the electronic device 2001 may be performed in the first electronic device 2002, the second external electronic device 2004, and/or the server 2006. When the electronic device 2001 should perform a certain function or service, the electronic device 2001 may request at least a portion of functions related to the function or service from the first electronic device 2002, the second external electronic device 2004, and/or the server 2006, instead of or in addition to performing the function or service for itself. The first electronic device 2002, the second external electronic device 2004, or the server 2006 may perform the requested function or additional function, and may transfer a result of the performance to the electronic device 2001. The electronic device 2001 may use a received result itself or additionally process the received result to provide the requested function or service. For example, a cloud computing technology, a distributed computing technology, or a client-server computing technology may be used.

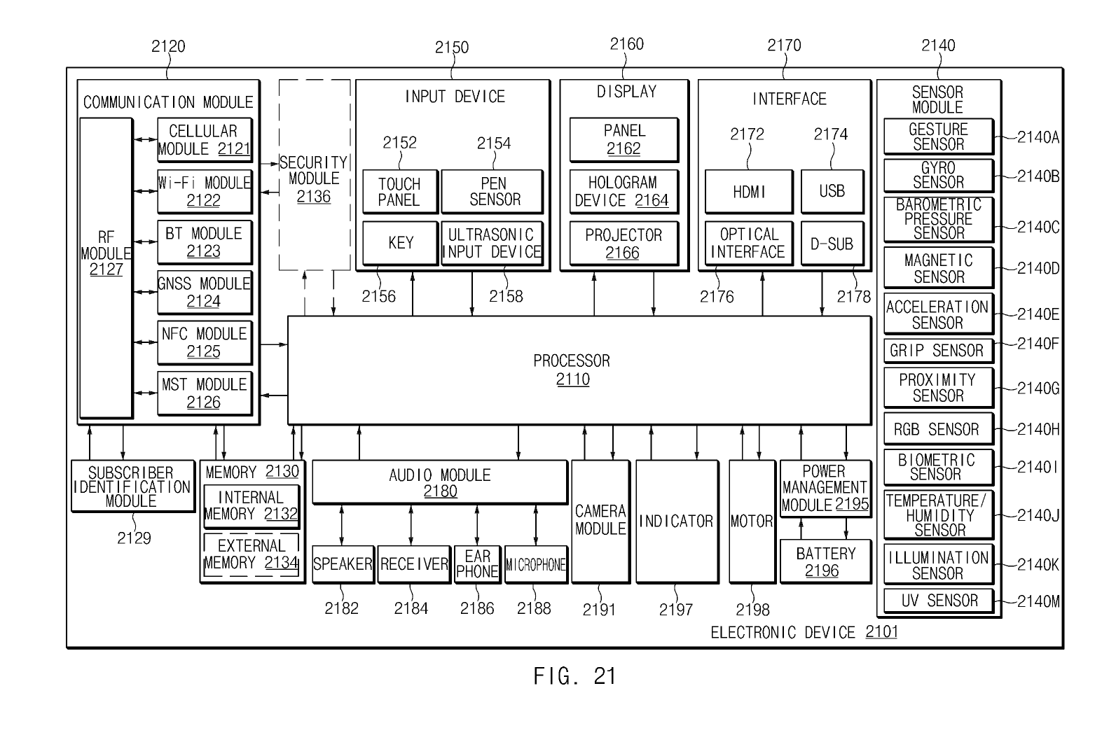

FIG. 21 illustrates an electronic device according to an embodiment of the present disclosure.

Referring to FIG. 21, an electronic device 2101 includes a processor 2110 (e.g., an AP), a communication module 2120, a subscriber identification module (SIM) 2129, a memory 2130, a security module 2136, a sensor module 2140, an input device 2150, a display 2160, an interface 2170, an audio module 2180, a camera module 2191, a power management module 2195, a battery 2196, an indicator 2197, and a motor 2198.

The processor 2110 may drive an OS or an application program to control a plurality of hardware or software components connected thereto and may process and compute a variety of data. The processor 2110 may be implemented with a system on chip (SoC). The processor 2110 may include a graphic processing unit (GPU) and/or an image signal processor. The processor 2110 may also include at least some of the other components illustrated in FIG. 21 (e.g., a cellular module 2121). The processor 2110 may load a command or data received from at least one of other components (e.g., a non-volatile memory) into a volatile memory to process the data and may store various data in a non-volatile memory.

The communication module 2120 includes the cellular module 2121, a Wi-Fi module 2122, a Bluetooth (BT) module 2123, a GNSS module 2124 (e.g., a GPS module, a Glonass module, a Beidou module, or a Galileo module), an NFC module 2125, an MST module 2126, and a radio frequency (RF) module 2127.

The cellular module 2121 may provide a voice call service, a video call service, a text message service, an Internet service, etc., through a communication network. The cellular module 2121 may identify and authenticate the electronic device 2101 in a communication network using the SIM 2129. The cellular module 2121 may perform at least part of functions which may be provided by the processor 2110. The cellular module 2121 may include a CP.

The Wi-Fi module 2122, the BT module 2123, the GNSS module 2124, the NFC module 2125, and/or the MST module 2126 may include a processor for processing data transmitted and received through the corresponding module. At least some of the cellular module 2121, the Wi-Fi module 2122, the BT module 2123, the GNSS module 2124, the NFC module 2125, or the MST module 2126 may be included in an integrated chip (IC) or one IC package.

The RF module 2127 may transmit and receive a communication signal (e.g., an to RF signal). The RF module 2127 may include a transceiver, a power amplifier module (PAM), a frequency filter, or a low noise amplifier (LNA), an antenna, etc. At least one of the cellular module 2121, the Wi-Fi module 2122, the BT module 2123, the GNSS module 2124, the NFC module 2125, or the MST module 2126 may transmit and receive an RF signal through a separate RF module.

The SIM 2129 may include a card which includes a SIM and/or an embedded SIM. The SIM 2129 may include unique identification information (e.g., an integrated circuit card identifier (ICCID)) or subscriber information (e.g., an international mobile subscriber identity (IMSI)).

The memory 2130 includes an embedded memory 2132 and an external memory 2134. The embedded memory 2132 may include at least one of a volatile memory (e.g., a dynamic random access memory (DRAM), a static RAM (SRAM), a synchronous dynamic RAM (SDRAM), and the like), or a non-volatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash memory or a NOR flash memory, and the like), a hard drive, or a solid state drive (SSD)).

The external memory 2134 may include a flash drive, for example, a compact flash (CF), a secure digital (SD), a micro-SD, a mini-SD, an extreme digital (xD), a multimedia car (MMC), or a memory stick, and the like. The external memory 2134 may operatively and/or physically connect with the electronic device 2101 through various interfaces.

The security module 2136 has a relatively higher secure level than the memory 2130 and may be a circuit that stores secure data and guarantees a protected execution environment. The security module 2136 may be implemented with a separate circuit and may include a separate processor. The security module 2136 may include an embedded secure element (eSE), which is present in a removable smart chip or a removable SD card or is embedded in a fixed chip of the electronic device 2101. The security module 2136 may be driven by an OS different from the OS of the electronic device 2101. For example, the security module 2136 may operate based on a java card open platform (JCOP) OS.

The sensor module 2140 may measure a physical quantity or may detect an operation state of the electronic device 2101, and may convert the measured or detected information to an electric signal. The sensor module 2140 includes a gesture sensor 2140A, a gyro sensor 2140B, a barometric pressure sensor 2140C, a magnetic sensor 2140D, an acceleration sensor 2140E, a grip sensor 2140F, a proximity sensor 2140G, a color sensor 2140H (e.g., red, green, blue (RGB) sensor), a biometric sensor 2140I, a temperature/humidity sensor 2140J, an illumination sensor 2140K, and an ultraviolet (UV) sensor 2140M. Additionally or alternatively, the sensor module 2140 may include an e-nose sensor, an electromyography (EMG) sensor, an electroencephalogram (EEG) sensor, an electrocardiogram (ECG) sensor, an infrared (IR) sensor, an iris sensor, a fingerprint sensor, etc. The sensor module 2140 may further include a control circuit for controlling at least one or more sensors included therein.

The electronic device 2101 may further include a processor configured to control the sensor module 2140, as part of the processor 2110 or to be independent of the processor 2110. While the processor 2110 is in a sleep state, the electronic device 2101 may control the sensor module 2140.

The input device 2150 includes a touch panel 2152, a (digital) pen sensor 2154, a key 2156, and an ultrasonic input device 2158.

The touch panel 2152 may use at least one of a capacitive type, a resistive type, an infrared type, or an ultrasonic type. The touch panel 2152 may further include a control circuit. The touch panel 2152 may further include a tactile layer that provides a tactile reaction to a user.

The (digital) pen sensor 2154 may be part of the touch panel 2152 or may include a separate sheet for recognition.

The key 2156 may include a physical button, an optical key, or a keypad.

The ultrasonic input device 2158 may allow the electronic device 2101 to detect a sound wave using a microphone 2188 and to verify data through an input tool generating an ultrasonic signal.

The display 2160 includes a panel 2162, a hologram device 2164, and a projector 2166. The panel 2162 may be flexible, transparent, and/or wearable. The panel 2162 and the touch panel 2152 may be integrated into one module.

The hologram device 2164 may show a stereoscopic image in a space using interference of light.

The projector 2166 may project light onto a screen to display an image. The screen may be positioned inside or outside the electronic device 2101.

The display 2160 may further include a control circuit for controlling the panel 2162, the hologram device 2164, and/or the projector 2166.

The interface 2170 includes a high-definition multimedia interface (HDMI) 2172, a universal serial bus (USB) 2174, an optical interface 2176, and a D-subminiature 2178. Additionally or alternatively, the interface 2170 may include a mobile high definition link (MHL) interface, an SD card/multimedia card (MMC) interface, and/or an infrared data association (IrDA) standard interface.

The audio module 2180 may convert a sound and an electric signal in dual directions. The audio module 2180 may process sound information input or output through a speaker 2182, a receiver 2184, an earphone 2186, and/or the microphone 2188.

The camera module 2191 captures a still image and a moving image. The camera module 2191 may include one or more image sensors (e.g., a front sensor or a rear sensor), a lens (not shown), an image signal processor (ISP), or a flash (e.g., an LED or a xenon lamp).

The power management module 2195 may manage power of the electronic device 2101. The power management module 2195 may include a power management integrated circuit (PMIC), a charger IC, and/or a battery gauge. The PMIC may have a wired charging method and/or a wireless charging method. The wireless charging method may include a magnetic resonance method, a magnetic induction method, an electromagnetic method, etc. An additional circuit for wireless charging, for example, a coil loop, a resonance circuit, a rectifier, etc., may be further provided.

The battery gauge may measure a remaining capacity of the battery 2196 and voltage, current, and/or temperature thereof, while the battery 2196 is charged. The battery 2196 may include a rechargeable battery or a solar battery.

The indicator 2197 may display a specific state of the electronic device 2101 or part (e.g., the processor 2110) thereof, for example, a booting state, a message state, a charging state, etc.

The motor 2198 may convert an electric signal into mechanical vibration and may generate vibration, a haptic effect, etc.

The electronic device 2101 may include a processing unit (e.g., a GPU) for supporting a mobile TV. The processing unit for supporting the mobile TV may process media data according to standards, for example, a digital multimedia broadcasting (DMB) standard, a digital video broadcasting (DVB) standard, a MediaFLO™ standard, etc.

Each of the above-mentioned elements of the electronic device according to an embodiment of the present disclosure may be configured with one or more components, and names of the corresponding elements may be changed according to the type of the electronic device. The electronic device may include at least one of the above-mentioned elements, some elements may be omitted from the electronic device, or other additional elements may be further included in the electronic device. Some of the elements of the electronic device may be combined with each other to form one entity, thereby making it possible to perform the functions of the corresponding elements in the same manner as before the combination.

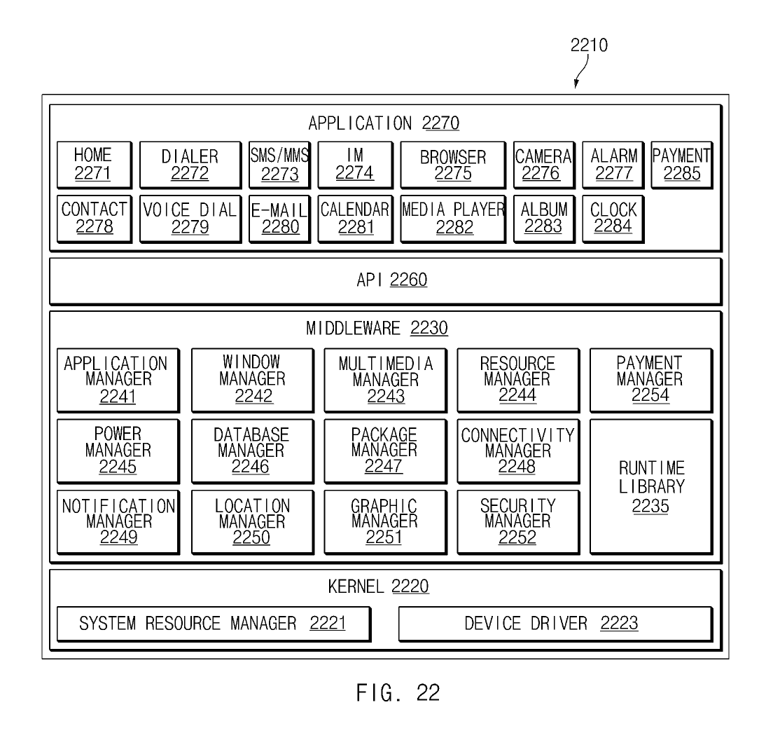

FIG. 22 illustrates a program module according to an embodiment of the present disclosure.

Referring to FIG. 22, the program module 2210 includes an OS for controlling resources associated with an electronic device and/or various applications, which are executed on the OS.

The program module 2210 includes a kernel 2220, a middleware 2230, an application programming interface (API) 2260, and applications 2270. At least part of the program module 2210 may be preloaded on the electronic device, or may be downloaded from an external electronic device.

The kernel 2220 includes a system resource manager 2221 and a device driver 2223. The system resource manager 2221 may control, assign, collect, etc., system resources. The system resource manager 2221 may include a process management unit, a memory management unit, a file system management unit, etc. The device driver 2223 may include a display driver, a camera driver, a Bluetooth (BT) driver, a shared memory driver, a USB driver, a keypad driver, a Wi-Fi driver, an audio driver, or an inter-process communication (IPC) driver.

The middleware 2230 may provide functions the applications 2270 use in common, and may provide various functions to the applications 2270 through the API 2260 such that the applications 2270 efficiently use limited system resources in the electronic device. The middleware 2230 includes a runtime library 2235, an application manager 2241, a window manager 2242, a multimedia manager 2243, a resource manager 2244, a power manager 2245, a database manager 2246, a package manager 2247, a connectivity manager 2248, a notification manager 2249, a location manager 2250, a graphic manager 2251, a security manager 2252, and a payment manager 2254.

The runtime library 2235 may include a library module used by a compiler to add a new function through a programming language while the applications 2270 are executed. The runtime library 2235 may perform a function about input and output management, memory management, or an arithmetic function.

The application manager 2241 may manage a life cycle of at least one of the applications 2270.

The window manager 2242 may manage graphic user interface (GUI) resources used on a screen of the electronic device.

The multimedia manager 2243 may determine a format utilized for reproducing various media files and may encode or decode a media file using a codec corresponding to the corresponding format.

The resource manager 2244 may manage source codes of at least one of the application 2270, and may manage resources of a memory, a storage space, etc.

The power manager 2245 may act together with a basic input/output system (BIOS) and the like, may manage a battery or a power source, and may provide power information utilized for an operation of the electronic device.

The database manager 2246 may generate, search, or change a database to be used in at least one of the application 2270.

The package manager 2247 may manage installation or update of an application distributed by a type of a package file.

The connectivity manager 2248 may manage a wireless connection, such as a Wi-Fi connection, a BT connection, etc.

The notification manager 2249 may display or notify events, such as an arrival message, an appointment, and proximity notification, by a method which is not disturbed to the user.

The location manager 2250 may manage location information of the electronic device.

The graphic manager 2251 may manage a graphic effect to be provided to the user or a user interface (UI) related to the graphic effect.

The security manager 2252 may provide all security functions utilized for system security, user authentication, etc.

When the electronic device has a phone function, the middleware 2230 may further include a telephony manager for managing a voice or video communication function of the electronic device.

The middleware 2230 may include a middleware module that configures combinations of various functions of the above-described components. The middleware 2230 may provide a module which specializes according to kinds of OSs to provide a differentiated function. Also, the middleware 2230 may dynamically delete some of old components or may add new components.

The API 2260 may be a set of API programming functions, and may be provided with different components according to OSs. For example, when using Android® or iOS®, one API set may be provided according to platforms. When using Tizen®, two or more API sets may be provided according to platforms.

The applications 2270 include a home application 2271, a dialer application 2272, a short message service/multimedia message service (SMS/MMS) application 2273, an instant message (IM) application 2274, a browser application 2275, a camera application 2276, an alarm application 2277, a contact application 2278, a voice dial application 2279, an e-mail application 2280, a calendar application 2281, a media player application 2282, an album application 2283, a clock application 2284, and a payment application 2285. Additionally or alternatively, the applications 2270 may include a health care application (e.g., an application for measuring quantity of exercise, blood sugar, etc.), or an environment information application (e.g., an application for providing atmospheric pressure information, humidity information, temperature information, etc.), etc.

The applications 2270 may also include an information exchange application for exchanging information between the electronic device and an external electronic device. The information exchange application may include a notification relay application for transmitting specific information to the external electronic device or a device management application for managing the external electronic device.

For example, the notification relay application may include a function of transmitting notification information, which is generated by other applications (e.g., the SMS/MMS application, the e-mail application, the health care application, the environment information application, etc.) of the electronic device, to the external electronic device. Also, the notification relay application may receive notification information from the external electronic device, and may provide the received notification information to the user of the electronic device.

The device management application may manage (e.g., install, delete, or update) at least one of functions of the external electronic device (e.g., a function of turning on/off the external electronic device itself (or partial components) or a function of adjusting brightness (or resolution) of a display) that communicates with the electronic device, an application that operates in the external electronic device, or a service (e.g., a call service or a message service) provided from the external electronic device.

The applications 2270 may include an application (e.g., the health card application of a mobile medical device) that is preset according to attributes of the external electronic device. The applications 2270 may include an application received from the external electronic device. The application 2270 may include a preloaded application or a third party application which may be downloaded from a server.

Names of the components of the program module 2210 according to various embodiments of the present disclosure may differ according to kinds of OSs.

At least part of the program module 2210 may be implemented with software, firmware, hardware, or at least two or more combinations thereof. At least part of the program module 2210 may be implemented (e.g., executed) by a processor (e.g., the processor 2110).

At least part of the program module 2210 may include a module, a program, a routine, sets of instructions, a process, etc., for performing one or more functions.

According to the above-described embodiments of the present disclosure, a problem of hiding an execution screen of an application program that is to use an object may be prevented by displaying a notification object in an indicator area of a portable electronic device.

According to the embodiments of the present disclosure, because the indicator area may remain displayed, even when an application program is switched, the notification object may be continuously displayed.

In addition, the present disclosure may provide various effects that are directly or indirectly recognized.

Herein, the term “module” may represent a unit including one of hardware, software, firmware, or a combination thereof. The term “module” may be interchangeably used with the terms “unit”, “logic”, “logical block”, “component” and “circuit”. A “module” may be a minimum unit of an integrated component or may be a part thereof. A “module” may be a minimum unit for performing one or more functions or a part thereof. A “module” may be implemented mechanically or electronically. For example, a “module” may include at least one of an application-specific integrated circuit (ASIC) chip, a field-programmable gate array (FPGA), and a programmable-logic device for performing some operations, which are known or will be developed.

At least a part of the devices (e.g., modules or functions thereof) or methods (e.g., operations) according to various embodiments of the present disclosure may be implemented as instructions stored in a computer-readable storage medium in the form of a program module. When the instructions are performed by a processor (e.g., the processor 2020), the processor may perform functions corresponding to the instructions. The computer-readable storage medium may be, for example, the memory 2030.

A computer-readable recording medium may include a hard disk, a floppy disk, a magnetic medium (e.g., a magnetic tape), an optical medium (e.g., CD-ROM, digital versatile disc (DVD)), a magneto-optical medium (e.g., a floptical disk), or a hardware device (e.g., a ROM, a RAM, a flash memory, etc.). The program instructions may include machine language codes generated by compilers and high-level language codes that can be executed by computers using interpreters. The above-mentioned hardware device may be configured to be operated as one or more software modules for performing operations of various embodiments of the present disclosure and vice versa.

For example, an electronic device may include a processor and a memory for storing computer-readable instructions. The memory may include instructions for performing the above-mentioned various methods or functions when executed by the processor. For example, the memory may include instructions that, when executed by the processor, cause the processor to acquire a user input that is related to registration of a notification about an object displayed on a display, register the object as a notification object in response to the user input, and display the registered notification object in an indicator area, in which states of functions supported by the portable electronic device are displayed, of a screen area of the display.

A module or a program module according to various embodiments of the present disclosure may include at least one of the above-mentioned elements, or some elements may be omitted or other additional elements may be added. Operations performed by the module, the program module or other elements according to various embodiments of the present disclosure may be performed in a sequential, parallel, iterative or heuristic way. Furthermore, some operations may be performed in another order or may be omitted, or other operations may be added.

While the present disclosure has been shown and described with reference to certain embodiments thereof, it will be understood by those skilled in the art that various changes in form and details may be made therein without departing from the scope of the present disclosure. Therefore, the scope of the present disclosure should not be defined as being limited to the above-described embodiments, but should be defined by the appended claims and any equivalents thereof.

What is claimed is:

1. A portable electronic device comprising:
a memory;
a display; and
a processor configured to:
receive a first user input for registering an object displayed on the display;
register the object as a notification object in response to the first user input; and
display the registered notification object in an indicator area of the display.

2. The portable electronic device of claim 1, wherein the processor is further configured to display a menu on the display, in response to receiving a second user input for selecting the object displayed on the display, and
wherein the first user input is received through the menu.

3. The portable electronic device of claim 1, wherein the processor is further configured to receive the first user input through a button object corresponding to a notification registration function provided in a soft input panel.

4. The portable electronic device of claim 1, wherein the processor is further configured to:
receive a second user input for selecting a first item comprising the object; and
display a menu that is related to the first item on the display, in response to receiving the second user input, and
wherein the first user input is received as an input for selecting a second item, which corresponds to a notification registration function, from among items included in the menu.

5. The portable electronic device of claim 4, wherein the first item comprises an image or a speech bubble that includes text.

6. The portable electronic device of claim 1, wherein the processor is further configured to store, in the memory, an object list including at least one of an identifier, a type, content, and a notification state of the notification object.

7. The portable electronic device of claim 1, wherein the processor is further configured to:
display a function control screen including a first display object corresponding to the notification object, in response to a second user input, the function control screen for changing configurations of functions supported by the portable electronic device or informing a user of a control signal generated by the portable electronic device on the display; and
perform at least one of a notification registration release function, a notification reregistration function, and a deletion function for the notification object, in response to a third user input through the function control screen.

8. The portable electronic device of claim 7, wherein the third user input selects the first display object corresponding to the notification object, and
wherein the processor is further configured to:
change the notification object to a notification enabled object and change the first display object corresponding to the notification object to a second display object corresponding to the notification enabled object, in response to the third user input; and
terminate displaying the notification object in the indicator area.

9. The portable electronic device of claim 8, wherein the processor is further configured to:
receive a fourth input for selecting the second display object corresponding to the notification enabled object;
change the notification enabled object to the notification object and change the second display object corresponding to the notification enabled object to the first display object corresponding to the notification object, in response to the fourth user input; and
display the notification object in the indicator area.

10. The portable electronic device of claim 8, wherein the processor is further configured to:
receive a fourth user input for selecting at least one of the first display object and the second display object provided on the function control screen;
delete the selected at least one of the first display object and the second display object from the function control screen in response to the fourth user input; and
if the selected at least one of the first display object and the second display object includes the first display object corresponding to the notification object, terminate displaying the notification object in the indicator area.

11. A method for displaying a notification object in a portable electronic device, the method comprising:
receiving a first user input for registering an object displayed on a display of the portable electronic device;
registering the object as a notification object in response to the first user input; and
displaying the registered notification object in an indicator area of the display.

12. The method of claim 11, further comprising displaying a menu on the display, in response to receiving a second user input for selecting the object displayed on the display,
wherein the first user input is received through the menu.

13. The method of claim 11, wherein receiving the first user input comprises receiving an input for selecting a button object corresponding to a notification registration function provided in a soft input panel.

14. The method of claim 11, further comprising:
receiving a second user input for selecting a first item including the object; and
displaying a menu that is related to the first item on the display, in response to receiving the second user input,
wherein receiving the first user input comprises receiving an input for selecting a second item, which corresponds to a notification registration function, from among items included in the menu.

15. The method of claim 11, further comprising storing, in a memory, an object list including at least one of an identifier, a type, content, and a notification state of the notification object.

16. The method of claim 11, further comprising:
displaying a function control screen including a first display object corresponding to the notification object, in response to a second user input, the function control screen for changing configurations of functions supported by the portable electronic device or informing a user of a control signal generated by the portable electronic device; and
performing at least one of a notification registration release function, a notification reregistration function, and a deletion function for the notification object, in response to a third user input through the function control screen.

17. The method of claim 16, wherein the third user input selects the first display object corresponding to the notification object, and
wherein performing the at least one of the notification registration release function, the notification reregistration function, and the deletion function for the notification object comprises:
changing the notification object to a notification enabled object and changing the first display object corresponding to the notification object to a second display object corresponding to the notification enabled object; and
terminating displaying the notification object in the indicator area.

18. The method of claim 17, further comprising:
receiving a fourth input for selecting the second display object corresponding to the notification enabled object;
changing the notification enabled object to the notification object and changing the second display object corresponding to the notification enabled object to the first display object corresponding to the notification object, in response to the fourth user input; and
displaying the notification object in the indicator area.

19. The method of claim 17, further comprising:
receiving a fourth user input for selecting at least one of the first display object and the second display object provided on the function control screen;
deleting the selected at least one of the first display object and the second display object from the function control screen, in response to the fourth user input; and
if the selected at least one of the first display object and the second display object includes the first display object corresponding to the notification object, terminating displaying the notification object in the indicator area.

20. A storage medium that stores a computer readable instruction, which when executed by a processor, instructs the processor to:
receive a first user input for registering an object displayed on a display;
register the object as a notification object in response to the first user input; and
display the registered notification object in an indicator area of the display.
